(19) United States
(12) Patent Application Publication
(10) Pub. No.: US 2024/0370412 A1
(43) Pub. Date: Nov. 7, 2024

(54) AGILE POLICY MANAGEMENT SYSTEM

(71) Applicant: Sophos Limited, Abingdon (GB)

(72) Inventor: Nikolay Ivanov Nikolaev, Abingdon (GB)

(21) Appl. No.: 18/653,769

(22) Filed: May 2, 2024

(30) Foreign Application Priority Data
May 5, 2023 (GB) 2306653.3

(51) Int. Cl. G06F 16/21; G06F 9/48; G06Q 10/0633

(52) U.S. Cl. CPC G06F 16/21; G06F 9/485; G06Q 10/0633

(57) ABSTRACT

The disclosure relates to deploying policy management rules to a first managed endpoint, comprising obtaining a layered data structure with a plurality of layers, wherein each layer comprises one or more nodes. For a first node, it is determined whether a stop criterion is met, wherein the stop criterion is associated with whether the first managed endpoint satisfies conditional expressions of a node. In the event the stop criterion is met, an identifier associated with the first node is assigned to the first managed endpoint. In the event the stop criterion is not met, a subsequent node in the layered data structure is traversed to until the stop criterion is met. The identifier associated with the subsequent node is then assigned to the first managed endpoint. Deployment of executable policy instructions to the first managed endpoint is based on the assigned identifier.

### CROSS-REFERENCE TO RELATED APPLICATIONS

This application claims priority to United Kingdom Pat. App. No. 2306653.3 filed on May 5, 2023, the entire content of which is hereby incorporated by reference herein.

### TECHNICAL FIELD

The present disclosure relates to system policy management control. Particularly, but not exclusively, the present disclosure relates to methods for operating an agile policy management system. Particularly but not exclusively, the present disclosure relates to methods for the organization, deployment, and/or distribution of policy management rules based on a layered data structure.

### BACKGROUND

In enterprises it is known to implement hardware and software policy management policies which are used to manage the use of computational resources within an enterprise. The policies can define, for example, what functionality or software is allowed to be used on a device, what hardware elements may be used, the users who are able to access a device etc. Such policies may be defined on multiple levels including global, departmental, team and individual. In large enterprises, which may comprise thousands of employees, there may be a significant number of policies.

Managing interactions and interfacing between enterprise system controllers and policy management specialists can be a complex process, and the multiple sources of policy instruction can result in both conflicts and redundancy. The sources of policy instruction can be from different departments and/or different entities and may be managed by different people. Policy managers also need to acquire intrinsic knowledge of the specific customer management topologies and infrastructure in order to define policy assignments. However, there are human and organizational limits to how much these can be understood and communicated, and there could also be serious usability and operational challenges.

Additionally, policy assignment rules and the reasoning of how they are applied to individual computers can be difficult to understand, adding to ambiguity and conflicts arising from many-to-many relationships between policies, groups, tags, sub-estates, administrators, etc. Furthermore, proliferation of policies driven by small variations in particular parts of their contents can lead to exponential increases in complexity and potential conflicts, increasing the necessary computational requirements and decreasing the efficiency and security of the enterprise system.

The present invention seeks to address some of the shortcomings of existing systems.

### SUMMARY OF DISCLOSURE

The present disclosure is directed to a scalable and highly adaptable method for the organization, deployment, and/or distribution of policy management rules based on a layered data structure. Use of the layered data structure allows for multiple distributed management options that delegate different aspects of the policy assignment ruleset assessment to be performed locally, as processes can be split between a remote server and a local hub. Overall, use of the layered data structure results in reduced complexity, improved operational characteristics and higher efficiency in managing endpoint security and policy.

There is described a computer-implemented method for deploying policy management rules to a first managed endpoint, wherein the first managed endpoint is preferably one of a plurality of managed endpoints of an enterprise system. The disclosure is further directed to a computer-implemented method for the organization of policy management rules for the distribution, deployment, and/or updating of policy management instructions. Additionally, the disclosure is related to the systems and computer readable mediums having stored thereon computer executable code that, when executed by one or more processors, perform the methods disclosed herein.

One aspect of the present disclosure relates to a computer-implemented method for deploying policy management rules to a first managed endpoint. The method comprises obtaining, at a server or system, a layered data structure comprising a plurality of layers. Each layer of the plurality of layers comprises one or more nodes, wherein each node of the one or more nodes is associated with an identifier, one or more conditional expressions, and one or more executable policy instructions. The method further comprises determining, for a first node within a first layer of the layered data structure, whether a stop criterion is met. The stop criterion is associated with whether the first managed endpoint satisfies one or more conditional expressions associated with a node of the one or more nodes. In the event the stop criterion is met, the identifier associated with the first node is assigned to the first managed endpoint. In the event the stop criterion is not met, the method further comprises traversing to a subsequent node in the layered data structure until the stop criterion is met and assigning the identifier associated with the subsequent node to the first managed endpoint. The method also comprises initiating deployment of the one or more executable policy instructions to the first managed endpoint based on the assigned identifier.

In another aspect of the present disclosure, a computer-implemented method performed at a first managed endpoint relates to assessing policy management rules at the first managed endpoint. The method first comprises receiving, from a server, one or more sets of conditional expressions associated with a layered data structure. The layered data structure comprises a plurality of layers, and each layer of the plurality of layers has one or more nodes. Each node of the one or more nodes is associated with an identifier, one or more executable policy instructions, and a set of conditional expressions of the one or more sets of conditional expressions. The method also comprises assessing whether the first managed endpoint satisfies a first set of conditional expressions associated with a first node based on information associated with the first managed endpoint. Based on the assessment, it is determined whether a stop criterion is met, wherein the stop criterion is associated with assessing whether the first managed endpoint satisfies a set of conditional expressions associated with a node of the one or more nodes. In the event the stop criterion is met, the method comprises identifying the first set of conditional expressions as a relevant set of conditional expressions. In the event the stop criterion is not met, a subsequent set of conditional expressions associated with a subsequent node in the layered data structure is assessed until the stop criterion is met. The subsequent set of conditional expressions associated as the relevant set of conditional expressions is then identified. The relevant set of conditional expressions is selected wherein the identifier of a relevant node associated with the selected relevant set of conditional expressions is assigned to the first managed endpoint. The method further comprises initiating deployment of one or more relevant executable policy instructions to the first managed endpoint based on requesting one or more executable policy instructions associated with the assigned identifier, the identifier of the relevant node, from the server.

Beneficially, the above methods allow for the targeted assignment of policy management rules to relevant managed endpoints. Targeted assignment based on a layered data structure results in a highly scalable policy management system, as policy assignment is efficiently structured based on the layered data structure which can be used for any number of control statements or conditional expressions. Additionally, the identifier associated with each node also allows for policy management identification, wherein an enterprise system controller or policy management specialist can identify which policies effect specific managed endpoints and vice versa.

Further beneficially, the methods allow for agile policy management rule assignment, as the assessment of policy management rules can be performed at the first managed endpoint. The first managed endpoint assesses the conditional expressions of the layered data structure, selects the relevant node associated with satisfied conditional expressions via use of a stop criterion, and can initiate deployment of the executable policy instructions associated with the selected node. When each managed endpoint of the enterprise system assesses the relevance/applicability of policy management rules for the respective managed endpoint, the processing resources required server-side are effectively decreased. For example, an enterprise system of two-thousand managed endpoints could result in the two-thousand processors of the managed endpoints being used for determining whether the conditional expressions of the layered data structure are satisfied by particular managed endpoints. Where such a determination requires information associated with each managed endpoint, the security of the enterprise system is increased, as information associated with the managed endpoints is not shared or otherwise accessed outside of the managed endpoints. Additionally, if a change to the operation of the first managed endpoint is detected, such as a change in user or hardware and/or software requirements, the first managed endpoint can repeat the assessment, selection, and deployment initiation process, so the most relevant policy management rules are applied to the first managed endpoint.

According to another aspect of the present disclosure, the present disclosure relates to a computer-implemented method for organization of policy management rules for distribution to a first endpoint. The method comprises receiving, at a server or system, a first set of control statements from one or more sources, wherein the first set of control statements are associated with policy management rules. The first set of control statements are transformed, at the same or different server or system, into a first set of conditional expressions based on predefined criteria, wherein the first set of conditional expressions are associated with properties of one or more managed endpoints. The method further comprises generating, at the same or different server or system, a layered data structure comprising a plurality of layers, wherein each layer of the plurality of layers has one or more nodes. Each node of the one or more nodes is associated with an identifier, one or more conditional expressions of the first set of conditional expressions, and one or more executable policy instructions. The one or more executable policy instructions represent executable code for implementation on the one or more managed endpoints. The method also comprises initiating distribution of the one or more executable policy instructions to a first managed endpoint based on the layered data structure.

Beneficially, organization of policy management rules based on a layered data structure helps prevent the creation of superfluous, or conflicting, system control instructions and unifies policy control from multiple different sources. It also decreases redundancy by not only preventing duplications, but also by streamlining the control statements into easily understandable, and optionally machine readable, conditional expressions. Compiling multiple control statements at a server allows for efficient detection of conflicting or overlapping policies, while initiating deployment can be performed by a local hub and/or managed endpoint, resulting in policy ruleset assessment performed locally.

According to another aspect of the present disclosure, the present disclosure relates to a computer-implemented method for distribution of updated policy management instructions to one or more managed endpoints. The method comprises obtaining, at a server or system, a layered data structure comprising a plurality of layers, wherein each layer of the plurality of layers comprises one or more nodes. Each node of the one or more nodes is associated with an identifier, one or more conditional expressions of a first set of conditional expressions, and one or more executable policy instructions. A change to a first policy instruction associated with the one or more executable policy instructions is identified and an executable patch instruction is generated, wherein the executable patch instruction represents the change to the first policy instruction. The method further comprises determining whether a first managed endpoint of the one or more managed endpoints is affected by the change to the first policy instruction. In the event the first managed endpoint is affected, the identifier associated with a first node of the one or more nodes is assigned to the first managed endpoint. The method also comprises initiating deployment of the executable patch instruction to the first managed endpoint based on the assigned identifier.

Beneficially, the method for patch generation and deployment results in increased adaptability, as small changes in policy do not result in policy proliferation. Additionally, updates to policy assignment can be initiated from a managed endpoint, a local hub, a system controller such as from a security specialist for the enterprise network, or at a server, which improves adaptability and both the efficiency and security of the enterprise system.

With all methods, the one or more sources of policy management rules are configured to deploy policy management rules to a server, and the server then organizes the policy management rules and/or initiates deployment of the policy management rules to the one or more managed endpoints. Beneficially, the one or more sources do not interact directly with the one or more managed endpoints, increasing the security of the system. Additionally, initiating deployment does not rely on instruction from the one or more sources or the server, allowing for local distribution of assigned policy instructions, such as in the event that a connection to the one or more sources is lost.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure but are intended to be illustrative only.

FIG. 1 shows a flowchart illustrating an example method for deploying management rules based on a layered data structure.

FIG. 2 shows a layered data structure example according to one aspect of the present disclosure.

FIG. 3 shows a flowchart illustrating a method for traversing a layered data structure.

FIG. 4 shows a flowchart illustrating a method for assigning an identifier to a first managed endpoint.

FIG. 5 shows a flowchart illustrating a method for initiating deployment of executable policy instructions.

FIG. 6 shows a flowchart illustrating a method for deploying management rules for one or more managed endpoints.

FIG. 7 shows a flowchart illustrating a method for organizing policy management rules based on generating a layered data structure.

FIG. 8 shows a flowchart illustrating a method for transforming control statements into conditional expressions.

FIG. 9 shows a flowchart illustrating a method for distributing updated policy instructions.

FIG. 10 shows a flowchart illustrating a method for identifying a change to a policy instruction.

FIG. 11 shows a flowchart illustrating a method for determining whether a managed endpoint is affected by a change to a policy instruction.

FIG. 12 shows an example system for orchestrating the organization, deployment, and/or updating of policy management rules.

FIG. 13 shows an example computing system for orchestration of the organization, deployment, and/or updating of policy management rules.

### DETAILED DESCRIPTION

Embodiments of the present disclosure will be now described with reference to the attached figures. It is to be noted that the following description is merely used for enabling the skilled person to understand the present disclosure, without any intention to limit the applicability of the present disclosure to other embodiments which could be readily understood and/or envisaged by the reader. Whilst the present disclosure is primarily directed to the automatic configuration of security settings within a cloud environment, the skilled person will readily appreciate that the systems, methods, and devices of the present disclosure are applicable to other areas of cybersecurity and could be employed to determine recommended security configurations for private enterprise networks and the like.

In the present disclosure, references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. The use of all examples, or exemplary language (“e.g.,” “such as,” “including,” or the like) provided herein, is intended merely to better illuminate the embodiments, and does not pose a limitation on the scope of the embodiments or the claims.

The skilled person will appreciate that the systems and methods of the present disclosure are not limited to a single programming language or paradigm. Indeed, the systems and methods of the present disclosure are applicable to any suitable programming language or environment, including but not limited to Java, C, C++, any suitable assembly language, Python, C#, a script language code e.g., JavaScript, Ruby, PHP, and the like.

Some embodiments described herein may relate to a computer storage product with a transitory, or non-transitory, computer-readable medium (also can be referred to as a transitory, or non-transitory, processor-readable medium) having instructions or computer code thereon for performing various computer implemented operations. The computer-readable medium (or processor readable medium) is non transitory in the sense that it does not include transitory propagating signals per se (e.g., a propagating electromagnetic wave carrying information on a transmission medium such as space or a cable). The media and computer code (also can be referred to as code) is those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a transitory computer program product, which can include, for example, the instructions and/or computer code discussed herein.

Some embodiments and/or methods described herein can be performed by software (executed on hardware), hardware, or a combination thereof. Hardware modules include, for example, a general-purpose processor, a field programmable gate array (FPGA), and/or an application specific integrated circuit (ASIC). Software modules (executed on hardware) can be expressed in a variety of software languages (e.g., computer code), including C, C++, Java, Ruby, Visual Basic, Python, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

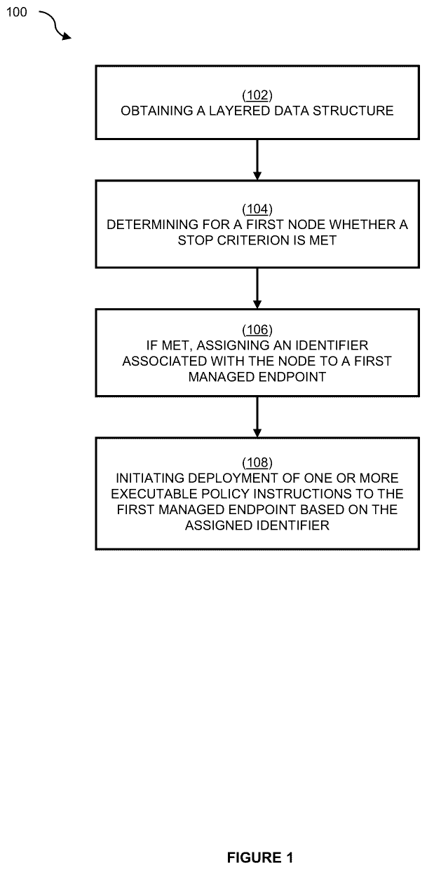

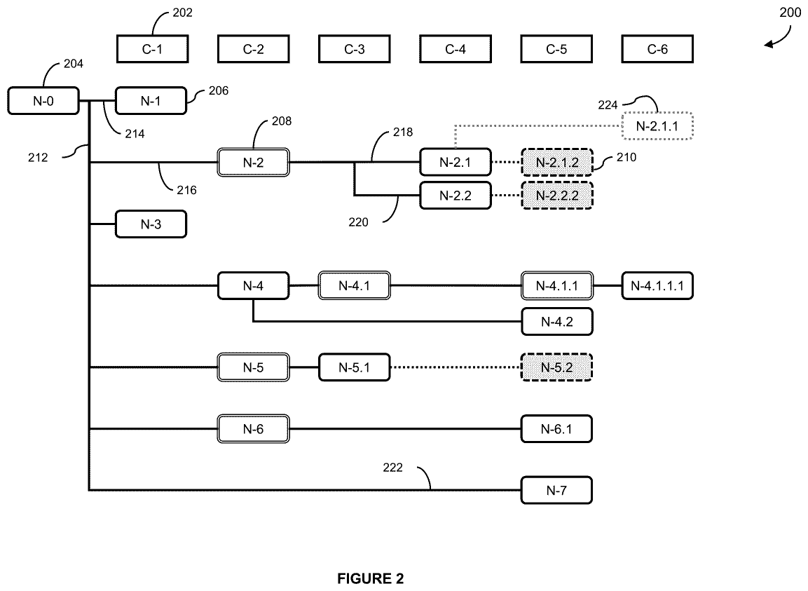

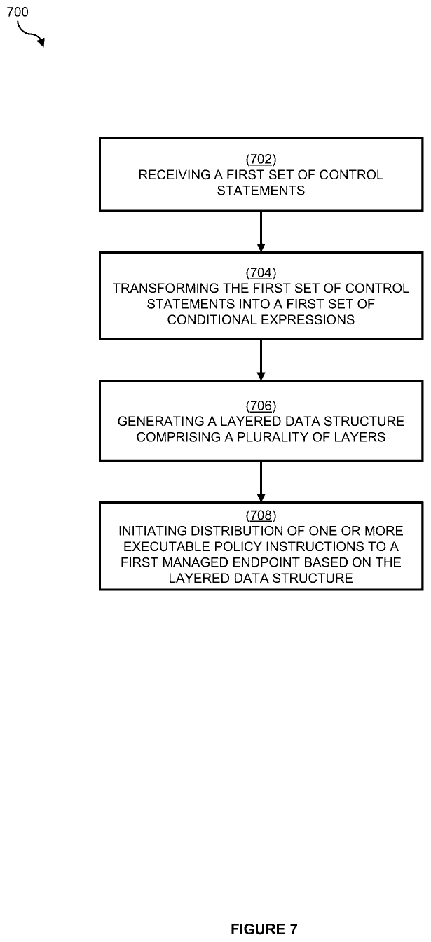

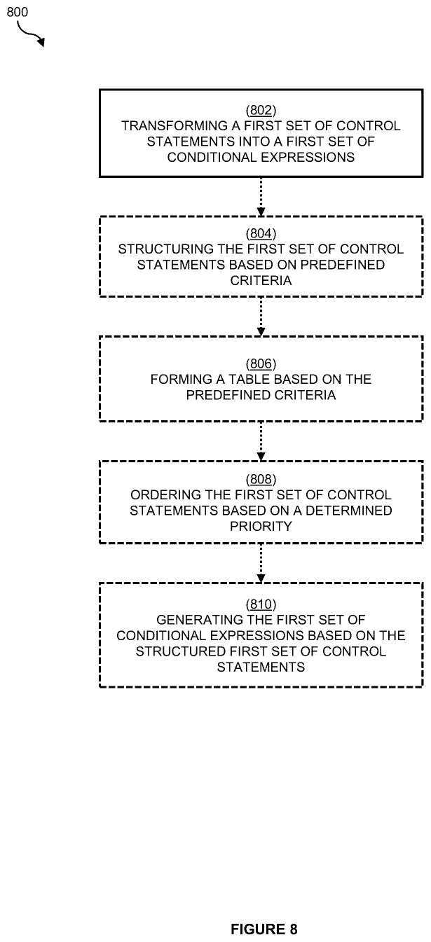

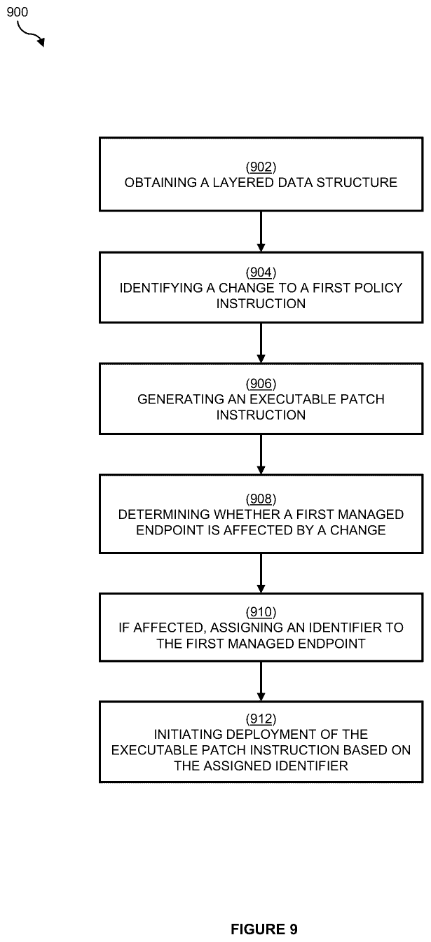

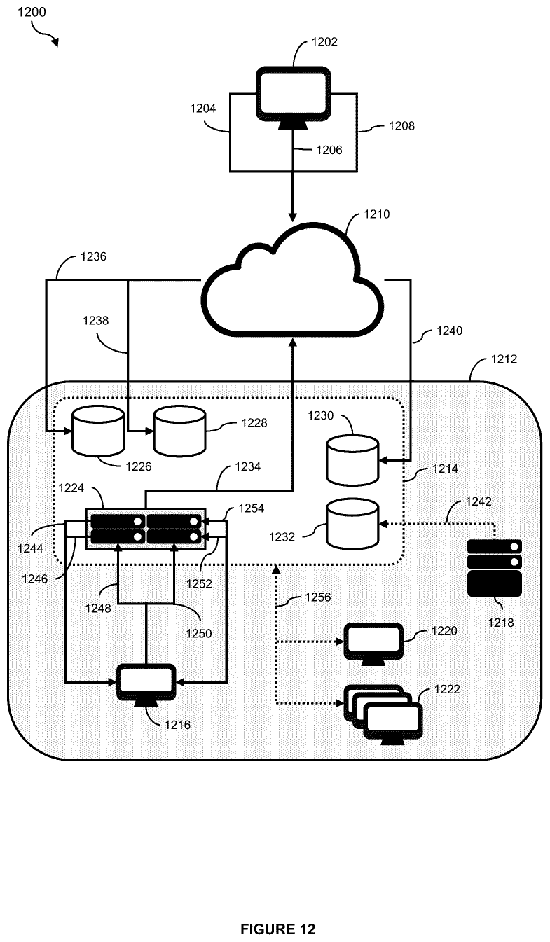

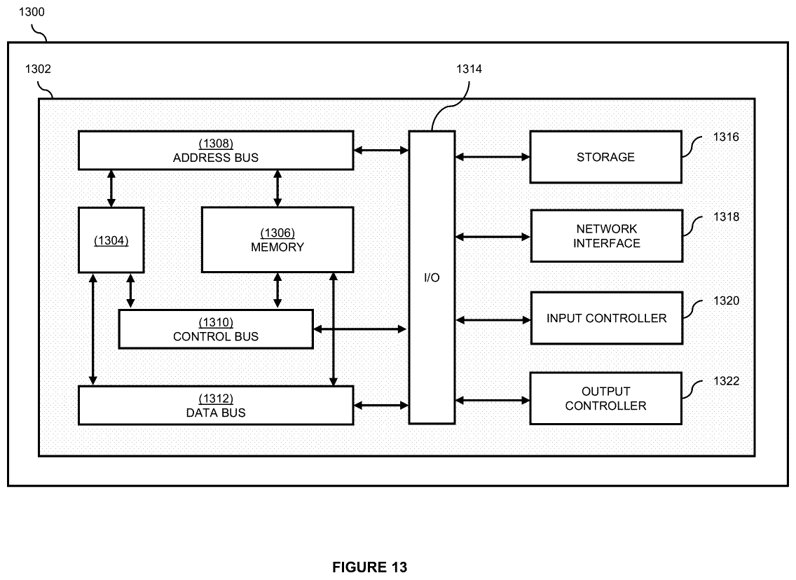

Methods 100 and 300-600 of FIG. 1 and FIGS. 3-6 are directed towards targeted deployment of policy management rules based on a layered data structure. An example layered data structure is illustrated in FIG. 2, although the skilled person would understand that any alternative layered data structure can be applied to the methods described herein. Methods 700-800 of FIGS. 7-8 are directed towards organizing policy management rules based on generating a layered data structure, and methods 900-1100 of FIGS. 9-11 are directed towards updating policy management rules. Policy management system 1200 of FIG. 12 is an example system for the implementation of any of the methods described herein, although the skilled person would understand that an alternative system can be used. Computing system 1300 of FIG. 13 is another example system for the implementation of any of the methods described herein, although the skilled person would understand that an alternative system can be used.

FIG. 1 shows a flowchart illustrating an example method for deploying management rules based on a layered data structure. Specifically, FIG. 1 illustrates a method 100 for deploying policy management rules to a first managed endpoint and is compatible with the processes of method 300, 400, 500, 600, 700, 800, 900, 1000, and/or 1100.

FIG. 1 represents a process for using a layered data structure for targeted deployment of policy management rules through assignment of policy management rules to relevant managed endpoints. Method 100 is used to deploy multiple policy management rules consistently and efficiently to an enterprise system of multiple managed endpoints. As described with reference to FIG. 2 the layered data structure comprises nodes, wherein each node defines a set of policy management rules, or conditions, which can be applied to an endpoint. The process in FIG. 1 allows for the identification of the relevant node which contains the rules applicable to a given endpoint. By structuring the rules, or conditions, in the layered data structure the rules can easily, and consistently, be applied to multiple endpoints. Once the node that is applicable to a given endpoint is identified, the policy management rules associated with node are applied to the endpoint, thus providing a method which allows for the consistent application of policy management rules across multiple endpoints in system or enterprise.

In enterprise systems with several thousands of managed endpoints, policy management implementation can be complex and inefficient. Using a layered data structure increases understandability, as managed endpoints and policy management rules are clearly and efficiently linked and/or mapped via the layered data structure. Additionally, the deployment is targeted, wherein a managed endpoint only receives policy management rules relevant to the managed endpoint and/or a user associated with the managed endpoint. Targeted deployment reduces the amount of time and computational resources required in implementing numerous policy management rules across multiple managed endpoints.

Furthermore, mapping of policy management rules to individual managed endpoints is based on assessment of the policy management rules performed by either a server or the managed endpoints. Beneficially, this allows for secure, resource efficient and time efficient deployment of one or more policy rules, which is adapted based on the enterprise system. Where the mapping of the policy management rules is applied at the endpoints this allows for easy and effective deployment of the policy management rules in an agile manner.

Method 100 comprises step 102, step 104, step 106, and step 108. Step 102 comprises obtaining a layered data structure; step 104 comprises determining for a first node whether a stop criterion is met; step 106 comprises, if the stop criterion is met, assigning an identifier associated with the node to a first managed endpoint; and step 108 comprises initiating deployment of one or more executable policy instructions to the first managed endpoint based on the assigned identifier. Method 100 is further detailed below.

Step 102 comprises obtaining, at a server, a layered data structure. The layered data structure comprises a plurality of layers, wherein each layer of the plurality of layers has one or more nodes. Each node of the one or more nodes is associated with an identifier, one or more conditional expressions, and one or more executable policy instructions. An example of the form of the layered data structure is described in detail with reference to FIG. 2.

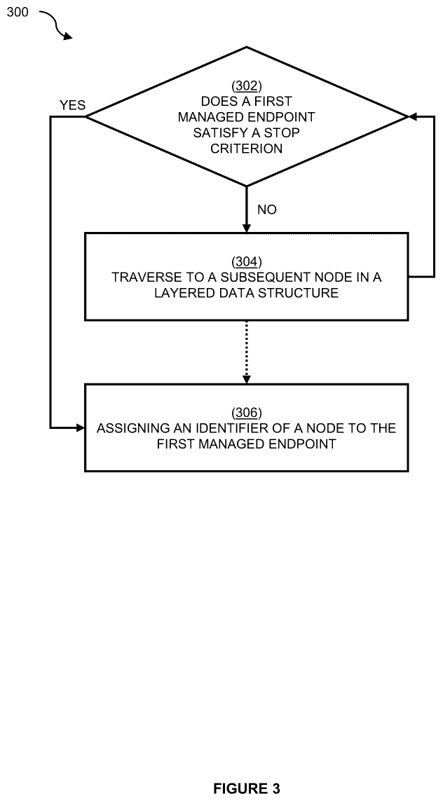

Step 104 comprises determining, for a first node within a first layer of the layered data structure, whether a stop criterion is met. Examples of determining whether a stop criterion is met is described in method 300 of FIG. 3. The stop criterion is associated with whether the first managed endpoint satisfies one or more conditional expressions associated with a node of the one or more nodes. The first node is not required to be the sequentially first node of the layered data structure and is any node of the layered data structure. Determining whether a stop criterion is met allows for determining whether the policy management rules associated with a specific node, such as the first node, are relevant to a specific managed endpoint, such as the first managed endpoint.

For example, one stop criterion is met if the first managed endpoint satisfies the one or more conditional expressions associated with the first node, and satisfies one or more conditional expressions associated with each node prior to the first node, but does not satisfy the one or more conditional expressions associated with a subsequent node. The first managed endpoint therefore satisfies this stop criterion for the first node based on the last conditional expression satisfied. Where each subsequent node represents at least one additional condition, a stop criterion based on the last conditional expression satisfied results in the identifier of the most relevant node being assigned. Alternatively, the stop criterion is based on an earliest conditional expression satisfied approach, a boundary condition approach, or a time based approach, which are described in detail in reference to method 300 of FIG. 3.

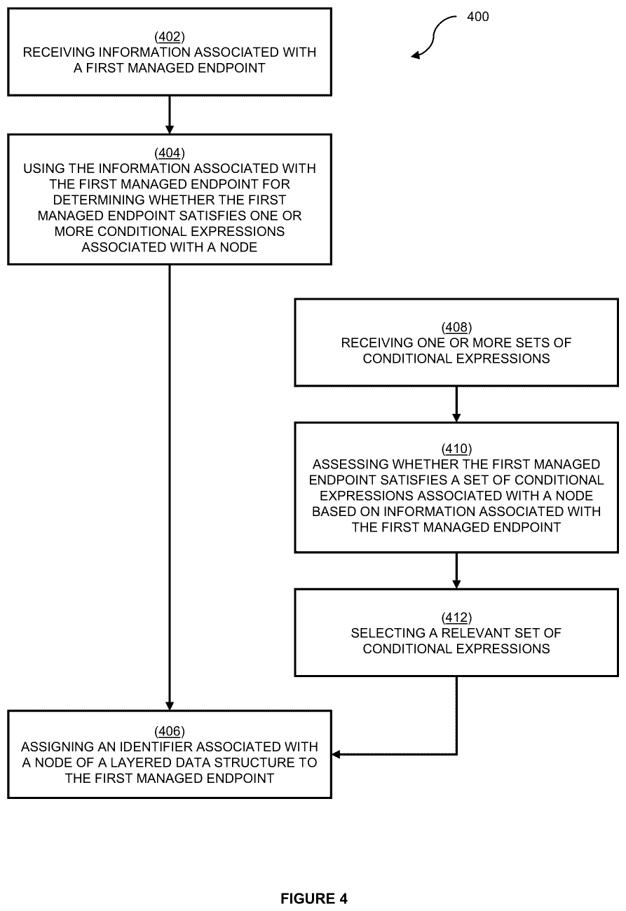

Step 106 comprises, in the event the stop criterion is met, assigning the identifier associated with the first node to the first managed endpoint. Assigning the identifier associated with the first node to the first managed endpoint helps map the first managed endpoint to the first node and vice versa. This is not only beneficial for targeted deployment, but is also beneficial for analysis and enterprise system monitoring, such as understanding how policy management rules affect certain managed endpoints. An example process for assigning the identifier associated with a node is described in detail in reference to method 400 of FIG. 4.

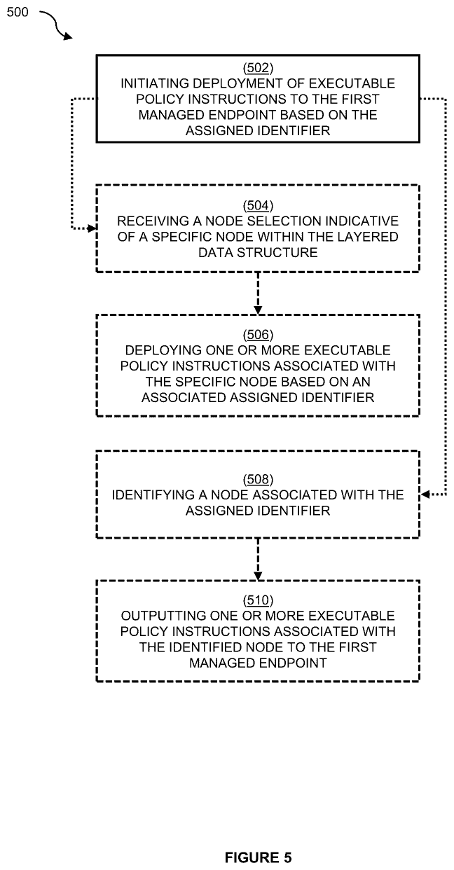

Step 108 comprises initiating deployment of the one or more executable policy instructions to the first managed endpoint based on the assigned identifier. Initiating deployment of executable policy instructions based on the identifier assigned to managed endpoints results in the deployment of relevant executable policy instructions to targeted managed endpoints. For example, if the first managed endpoint is assigned the identifier associated with the first node, deployment of the one or more executable policy instructions associated with the first node to the first managed endpoint is initiated. If the first managed endpoint is assigned the identifier associated with the subsequent node, deployment of the one or more executable policy instructions associated with the subsequent node to the first managed endpoint is initiated. Initiating deployment based on the assigned identifier is described in detail in reference to method 500 of FIG. 5.

The layered data structure, such as the layered data structure of FIG. 2, is obtained from the same server, a different server, and/or generated by a server (e.g. method 700 of FIG. 7). Obtaining a layered data structure allows for the layered data structure to be generated, rendered, and/or evaluated at a different time and/or location from using the layered data structure for targeted deployment. For example, generation at a first server and deployment at a second server allows for local-based deployment, such as on-sight controlled deployment, while the generation and/or maintenance associated with the layered data structure is performed off-sight, such as at a secure cloud server. Optionally, the layered data structure is a hierarchical tree, and/or the layered data structure is a list.

A node comprises any of one or more access right definitions, data or metadata describing the node, or a policy identifier. For example, a node comprises a description message which represents the policy and/or conditions associated with the node in an understandable format. The one or more conditional expressions represent if/else statements, comprise script language code, and/or comprise readable human language. Examples of script language code include JavaScript, Ruby, PHP, and the like. The one or more conditional expressions are stored at the server or stored locally in a first cache. Additionally, or alternatively, step 102 further comprises any of the steps of method 600, specifically step 602, and/or any of the steps of method 700, specifically steps 702 and step 704. Optionally, one or more nodes of the layered data structure is a further layered data structure.

An executable policy instruction represents a set of configuration settings received at the first managed endpoint from the server and stored or otherwise persisted at the first managed endpoint, such as in a policy store of the first managed endpoint from which software components read and apply these configuration settings. Beneficially, this allows for the agile execution of configuration settings for a specific operation of the first managed endpoint, such as associated with a particular user or location of the first managed endpoint. Optionally, executable policy instructions are instructions regarding modifications to configuration settings that, once executed, impact the operation of the first managed endpoint.

Optionally, step 104 comprises determining, for a first managed endpoint, whether a stop criterion is met for a first node within a first layer of the layered data structure, such as using method 300 of FIG. 3.

In one example of step 104, the stop criterion associated with a first node is based on the first managed endpoint satisfying the one or more conditional expressions associated with a first node (e.g. node labelled N-2.1 in FIG. 2) but not satisfying the one or more conditional expressions associated with a subsequent node (e.g. node labelled N-2.1.1 in FIG. 2). Where the layered data structure is an ordered tree, this example results in a first managed endpoint being assigned the identifier of the last node that is relevant to the first managed endpoint. Beneficially, this allows for a quick and efficient targeted assignment of a policy management rule where a plurality of conditions is required associated with the first managed endpoint for the policy management rule to be relevant, without resulting in blanket policy management rule deployment.

In another example where the layered data structure is in an ordered list, such that nodes are traversed and assessed sequentially, the stop criterion associated with a first node is based on the first managed endpoint satisfying the one or more conditional expressions associated with a first node, and traversal stops. This example results in a first managed endpoint being assigned the identifier of the earliest and/or initial node that is relevant to the first manage endpoint. In a further example, the stop criterion is based on a number of layers of the layered data structure.

Optionally, step 104 further comprises receiving information associated with the first managed endpoint from one or more sources and using the information associated with the first managed endpoint for determining whether the first managed endpoint satisfies the one or more conditional expressions associated with a node of the one or more nodes. In one example, the information associated with the first managed endpoint comprises domain group data received from a domain controller and/or the information associated with the first managed endpoint is received from the first managed endpoint. For example, the information associated with the first managed endpoint comprises any of: defined group classification data; system information; hardware information; system health data; installed applications; or detected threats.

Preferably, step 104 is performed at the first managed endpoint, wherein conditional expressions are deployed from the server to the first managed endpoint for assessment. Whilst the process is described with reference to the first managed endpoint it may be repeated for multiple managed endpoints simultaneously or sequentially.

Beneficially, this allows for processing operations such as assessing whether one or more conditional expressions associated with the first node are satisfied by the first managed endpoint to be performed away from the server. When applied to the context of an enterprise system with a plurality of managed endpoints (which may number on the thousands), there is potentially a large number of managed processors capable of determining whether a stop criterion is met for the respective managed endpoint, effectively increasing the speed of step 104 and reducing the resources required server-side. Such a distributed system improves the speed and efficiency of initiating deployment of one or more relevant executable policy instructions to the first managed endpoint, it also improves security as it reduces the data flows between the server and the first managed endpoint as the assessment is performed away from the server. For example, information associated with the first managed endpoint is not accessed by the server to determine whether the conditional expressions are satisfied by the first managed endpoint.

Optionally, in the event the stop criterion is not met, step 106 further comprises traversing to a subsequent node in the layered data structure until the stop criterion is met. The identifier associated with the subsequent node is then assigned to the first managed endpoint. Traversal is described in detail in reference to method 300 in FIG. 3.

Optionally, initiating deployment of step 108 comprises identifying a node associated with the identifier assigned to the first managed endpoint and outputting the one or more executable policy instructions associated with the identified node to the first managed endpoint. For example, initiating deployment comprises receiving a node selection, wherein the node selection indicates a specific node within the layered data structure, and deploying the one or more executable policy instructions associated with the specific node of the node selection based on the assigned identifier associated with the specific node. The node selection indicates one node or a plurality of nodes.

Optionally, step 108 comprises initiating the execution of one or more policy instructions at the first managed endpoint.

Preferably, method 100 is performed in a sequential order as shown in FIG. 1. Alternatively, steps 102, 104, 106, and/or 108 may be performed in any order if steps are repeated for one or more additional nodes and/or one or more additional managed endpoints.

Beneficially, method 100 results in a highly scalable policy management system, as policy assignment is efficiently structured based on the layered data structure, which can be used for any number of control statements or conditional expressions. The executable policy instructions may only be deployed to managed endpoints that are instructed to implement the executable policy instruction based on the policy management rules, further increasing the efficiency and security of the implementation of policy management rules for a managed enterprise system. Additionally, or alternatively, the managed endpoints of the enterprise system perform step 104, delegating resource requirements away from the server and, unlike traditional systems, increasing the efficiency of the system as more managed endpoints are added. Method 100 also increases the security of the system, as in some embodiments a managed endpoint does not receive the layered data structure and, in some embodiments, the server does not receive information associated with the first managed endpoint used in determining whether a stop criterion is met.

FIG. 2 shows a layered data structure example according to one aspect of the present disclosure. In this example, the layered data structure 200 is a hierarchical tree such as a decision tree.

The layered data structure 200 is associated with one or more conditions 202 and comprises one or more nodes, including any of: a root node 204, one or more leaf nodes 206, one or more continuation nodes 208, and/or one or more pruned nodes 210. The one or more nodes are linked with branches, such as main branch 212, first branch 214, second branch 216, first split branch 218 and second split branch 220, and seventh branch 222. Not all the nodes, branches, and conditions of the layered data structure are labelled. Additionally, some nodes are depicted for illustrative purposes and are not otherwise part of the layered data structure 200, such as unassigned node 224.

The layered data structure 200 is used to organize policy management rules and to deploy implementation of policy management rules to targeted managed endpoints. Policy management rules are organized based on predefined criteria associated with conditions 202. In layered data structure 200, the different layers represent different priorities associated with the policy management rules. Targeted deployment depends on whether a managed endpoint meets the one or more conditions 202 associated with a node (206, 208).

For example, layered data structure 200 is used for deployment and is the layered data structure of method 100. Initially, layered data structure 200 is obtained at a server. Then, it is determined for leaf node 206 labelled N-2.1 whether a stop criterion is met, and determining whether the first managed endpoint satisfies the conditions 202 associated with N-2.1, labelled C-4. The stop criterion associated with nodes N-2 and N-1 were not met for the first managed endpoint. If the stop criterion for node N-2.1 is met, an identifier associated with N-2.1 is assigned to a first managed endpoint performed, for example, using step 106 of method 100. In the example described here, the stop criterion for N-2.1 is met, because the first managed endpoint satisfies the conditions 202 associated with N-2.1 but does not satisfy the conditions associated with subsequent nodes N-2.1.1 (an unassigned node 224) or N-2.1.2 (a pruned node 210). Therefore, the identifier associated with N-2.1 is assigned to the first managed endpoint. Deployment of one or more executable policy instructions associated with N-2.1 to the first managed endpoint can then be initiated, as described in detail in reference to method 100 of FIG. 1.

The determinants used in conditions 202 are put in an order that defines the one or more layers of the layered data structure 200 (e.g. seven layers). The one or more nodes at each layer are ordered in descending order by their rank, wherein the highest priority value of any policy is mapped to a policy management rule within its subtree. If the priority order of the policies or the order of the determinants changes, the tree is re-constructed and, optionally, re-evaluated.

In layered data structure 200 depicted in FIG. 2, there are 6 conditions 202, labelled C-1 for a first condition, C-2 for a second condition, etc. up until C-6 for the sixth condition. However, a layered data structure 200 may be organized with any number of conditions 202, wherein each node within the layered data structure 200 represents at least one condition 202 within a rule. For example: C-1 is a condition related to policy, such as a policy for monitoring peripheral devices associated with a managed endpoint (e.g. the first managed endpoint of FIG. 1); C-2 is a condition relating to large geographical location, such as a country; C-3 is a condition relating to small geographical location, such as a an office location; C-4 is a condition relating to an operating system of a managed endpoint, such as Windows 11 (RTM); C-5 is a condition relating to a department, such as engineering or marketing; and C-6 is a condition relating to purpose, such as security testing. Other examples include any condition related to controlling or otherwise managing security and access policies of an enterprise system, such as policy management system 1200.

The root node 204 is labelled N-0, and represents a default policy. For example, if none of the rules within the children subtrees has been matched than the evaluation result is the root node. For layered data structure 200, the root node 204 is not associated with a condition 202. However, the root node 204 can optionally be associated with a blanket condition such as whether a managed endpoint is associated with the enterprise system.

The one or more leaf nodes 206 represent a final condition, which is a condition that is evaluated to be true. Depending on the stop criterion, the one or more leaf nodes 206 also represent where conditions associated with previous nodes connected to the leaf node 206 via a branch (parent nodes) are evaluated to be true. The one or more leaf nodes 206 in layered data structure 200 are labelled N-1, N-2.1, N-2.2, N-3, N-4, N-4.1.1.1, N-4.2, N-5.1, N-6.1, and N-7.

The continuation nodes 208 are nodes that are traversed between the root node 204 and a leaf node 206 and, depending on the stop criterion, represent conditions that are met. For example, the continuation node 208 labelled N-2 represents a condition that is met but is not a final condition and continuation node 208 labelled N-2 is traversed between the root node 204 labelled N-0 and the leaf nodes 206 labelled N-2.1 and N-2.2.

Pruned nodes 210 represent conditions of lower ranking and/or priority than conditions associated with leaf nodes 206. If a branch representing a new policy management rule partially overlaps existing branch, the branches are merged. The one or more nodes on the overlapping branch proceeding a leaf node 206 on the existing branch become pruned nodes 210. The pruning of nodes is provisional based on there being no existing leaf nodes on the overlapping branch. For example, the branch of pruned node 210 labelled N-5.2 partially overlapped with the branch of leaf node 206 labelled N-5.1, and therefore the branches are merged and N-5.2 is a pruned node 210.

Additional nodes may be generated but not included in the rendered layered data structure 200. For example, the node labelled N-2.1.1 may be generated but is not included, as it is not relevant to any of the managed endpoints and/or overlaps with an included node.

Beneficially, incorporating pruned nodes 210 within the layered data structure 200 decreases redundancy in the layered data structure 200. Pruned nodes 210 are excluded from evaluation, decreasing both the time and computing resources required for performing the methods described in any of FIG. 1 and FIGS. 3-10. In one example, C-2 refers to a country condition, C-3 refers to an office condition, and C-5 refers to a department condition. For example, in a scenario where one or more managed endpoints are used by the marketing department in a first country, the marketing department may wholly operate out of a single office, and therefore the C-5 condition overlaps with the C-3 condition. Consequently, a policy assignment rule regarding the single office location in the first country (e.g. represented by node N-5.1) would also encompass a policy assignment rule regarding the marketing department in the first country (e.g. represented by node N-5.2). As such, the policy assignment rule regarding the marketing department in the first country is redundant, and node N-5.2 is a pruned node 210.

If a pruned node 210 becomes relevant to a managed endpoint, such as by a small modification to the policy associated with the pruned node 210, the pruned node 210 becomes a leaf node 206. Alternatively, a patch can be applied to the relevant managed endpoint to implement the policy instructions related to the small modification. In reference to the above example, a relevant managed endpoint is associated with the marketing department in the single office location in the first country. The relevant managed endpoint requires access to secure data that is blocked to other managed endpoints in the single office location, which are not associated with the marketing department. The relevant managed endpoint receives executable policy instructions associated with the leaf node N-5.1 and an executable patch instruction representing the difference in policy associated with pruned node N-5.2, such as allowing the relevant managed endpoint access to the secure data associated with marketing that is otherwise restricted due to General Data Protection Regulation regulations. Patches therefore prevent the inclusion of additional leaf nodes 206 and continuation nodes 208 from small modification to policies associated with the layered data structure 200, eliminating the need for adding additional nodes. Patches are described in detail in reference to methods 900-1100 of FIGS. 9-11.

When all policy management rules are processed, the policies in all branches with multiple leaf nodes 206, such as second branch 216, are analyzed for conflicts. If required, new policies with merged content are created and corresponding new policy management rules are formed. For example, leaf node 206 labelled N-4.2 represents a new policy management rule that merges two or more relevant policy management rules. For example, a first policy management rule allows access to Wi-Fi in a second country (represented by leaf node 206 labelled N-4) and a second policy management rule allows access to an optical drive in the marketing department. Therefore, the new policy management rule allows access to Wi-Fi and an optical drive to the marketing department in the second country (represented by leaf node 206 labelled N-4.2).

In one example, the layered data structure 200 is traversed and evaluated sequentially top to bottom and traversal stops when there is a match of policy management rule within a subtree rooted at the currently evaluated node. If a node is a leaf node 206, a rule matching pointer is set to the identifier associated with the node, such as N-4, and the evaluation continues further with the children of that node, such as N-4.1 and N-4.2. If a node is not a leaf node 206, the rule matching pointer remains unchanged, and the evaluation continues further with the children of that node. The rule matching pointer is initiated at the identifier associated with the default root node 204, such as N-0.

The unassigned nodes 224 represent policy management rules that are not relevant to the enterprise. For example, N-2.1.1 is associated with conditions that are not met by any managed endpoint within the enterprise system. In another example, N-2.1.1 is a repetition of N-2.1.2, and therefore redundant. In another example, N-2.1.1 represents a policy management rule that is conflicting with the policy management rule represented by a higher priority node, such as N-2.1, and N-2.1.1 is therefore not used.

Optionally, a node may represent a nested layered data structure within layered data structure 200.

Layered data structure 200 can be generated using any of the steps of method 700 and/or method 800. Other structures for layered data structure 200 not depicted here include list-based structures, cluster-based structures, alternative tree-based structures, and/or a structure where one or more nodes of a layered data structure comprise at least one further layered data structure.

For example, layered data structure 200 can be represented as a table or an ordered list. The node structure of FIG. 2 allows for concise and efficient visualization and implementation of multiple policy control statements, which is beneficial for analyzing and modifying the rules applied to the one or more managed endpoints of a policy-managed system, such as policy management system 1200. Optionally, layered data structure 200 is exported as an ordered list and/or table. For example, an ordered list is generated by exporting all distinct paths to a leaf node 206. Beneficially, the process of list-based representation allows for comparison between original requirements, such as the control statements, and the one or more conditional expressions associated with each node, which can be used for constructing scripts or other rule evaluation tools.

Beneficially, use of layered data structure 200 for the organization of policy management rules helps prevent the creation of superfluous, even conflicting, system control instructions and unifies policy control from multiple different sources. It also decreases redundancy by not only preventing duplications, but also by streamlining the control statements into easily understandable, and optionally machine readable, conditional expressions. Compiling multiple control statements at a server allows for efficient detection of conflicting or overlapping policies, while initiating deployment can be performed by a local hub and/or managed endpoint, resulting in policy ruleset assessment performed locally. Use of layered data structure 200 for deployment allows for the targeted assignment of policy management rules to relevant managed endpoints. This results in a highly scalable policy management system, as policy assignment is efficiently structured based on the layered data structure which can be used for any number of control statements or conditional expressions.

Additionally, the identifier associated with each node also allows for policy management identification, wherein an enterprise system controller or policy management specialist can identify which policies effect specific managed endpoints and vice versa. For example, an enterprise system controller can select node N-2.1 and be provided with data indicative of which managed endpoints, if any, are assigned the identifier associated with N-2.1, such as a list of managed endpoints. In another example, and enterprise system controller can select one or more managed endpoints and be provided with data indicative of which node(s) are linked to the selected managed endpoints based on the assigned identifiers associated with the node(s).

FIG. 3 shows a flowchart illustrating a method for traversing a layered data structure. Specifically, FIG. 3 illustrates a method 300 for traversing to a subsequent node in a layered data structure (e.g. layered data structure 200) and is compatible with the processes of method 100, 400, 500, 600, 700, 800, 900, 1000, and/or 1100.

Method 300 is an example method for traversing a layered data structure until a stop criterion is met. As the layered data structure for a large enterprise system could also be large, consisting of hundreds of nodes or more, efficient traversal is required to limit the time taken for assigning node identifiers to managed endpoints and keep the computing resource requirements low. Method 300 allows for the conditions associated with the nodes of the layered data structure to be assessed in an efficient process, whether the stop criterion is a simple earliest conditional expression satisfied approach or a more complex last conditional expressions satisfied approach. Consequently, method 300 results in improved efficiency when performing targeted policy management rule assignment.

Method 300 comprises step 302, step 304, and step 306. Step 302 comprises determining if a first managed endpoint satisfies a stop criterion, wherein the determination is made to have output options of either the stop criterion being met, or the stop criterion not being met. Step 304 comprises traversing to a subsequent node in a layered data structure. Step 306 comprises assigning an identifier of a node to the first managed endpoint. The steps are detailed further below.

In a previous example of layered data structure 200 of FIG. 2 being used for deployment, the identifier associated with N-2.1 was assigned to the first managed endpoint. Using method 300, it is determined whether the first managed endpoint satisfies the stop criterion for N-1. As the stop criterion is not met, a subsequent node in the layered data structure is traversed to. In the present example, the subsequent node is N-2, on a subsequent layer. It is then determined whether the first managed endpoint satisfies the stop criterion for N-2, such as by repeating the process of step 302. As the stop criterion is not met, a subsequent node in the layered data structure is traversed to. The subsequent node is N-2.1, on the same layer. It is then determined whether the first managed endpoint satisfies the stop criterion for N-2.1. As the stop criterion is met, the identifier associated with N-2.1 is assigned to the first managed endpoint, such as using the process of step 306. Deployment of one or more executable policy instructions associated with N-2.1 to the first managed endpoint can then be initiated, such as using the process of step 108 of method 100.

Step 302 comprises determining whether a first managed endpoint satisfies a stop criterion. For example, at a first node (e.g. node N-1 of layered data structure 200), the first managed endpoint may or may not satisfy the stop criterion, which is associated with whether the first managed endpoint satisfies one or more conditional expressions, such as the one or more conditional expressions associated with the first node. If the first managed endpoint does not satisfy the stop criterion, the method progresses to step 304. If the first managed endpoint does satisfy the stop criterion, the method progresses to step 306.

Step 304 comprises traversing to a subsequent node in a layered data structure. For example, traversing to a second node, which may or may not be in a subsequent layer of the layered data structure (e.g. traversing to node N-2 of layered data structure 200). After traversing to the subsequent node, step 302 is repeated, wherein it is determined whether the first managed endpoint satisfies a stop criterion, which is associated with whether the first managed endpoint satisfies one or more conditional expressions associated with the subsequent node.

Step 306 comprises assigning an identifier of a node to the first managed endpoint, wherein the identifier of the node is associated with the stop criterion. For example, if the first managed endpoint satisfies the stop criterion associated with a first node, the identifier of the first node is assigned to the first managed endpoint and/or if the first managed endpoint satisfies a stop criterion associated with a second node, the identifier of the second node is assigned to the first managed endpoint.

In one example, the stop criterion associated with a first node is based on the first managed endpoint satisfying the one or more conditional expressions associated with a first node, for example a leaf node 206, N-2.1, but not satisfying the one or more conditional expressions associated with a subsequent node N-2.1.1. In the event of there being no further sequential nodes, the stop criterion is met if the one or more conditional expressions associated with the final node are satisfied. Additionally or alternatively, the stop criterion is based on a last conditional expression satisfied approach, wherein the first managed endpoint is assigned to the node associated with the last conditional expressions satisfied. Beneficially, this stop criterion allows for policy management rules to be deployed to managed endpoints that satisfy increasingly specific conditions. If none of the conditional expressions are satisfied, the first managed endpoint is associated with the default root node, which is associated with the default base policy of the enterprise system.

For example, the first managed endpoint runs Windows 11 (RTM) and is used for firewall management. Using layered data structure 200 of FIG. 2, condition C-4 is associated with N-2.1 and is, for example, a condition relating to Windows 11 (RTM). The first managed endpoint operates a version of Windows 11 (RTM), and therefore satisfies the condition of C-4. N-2.1.1 is associated with condition C-6 and, for example, C-6 is a condition relating to a purpose of testing new peripheral devices. As the first managed endpoint is used for firewall management, it is not used for testing new peripheral devices, and does not meet the condition associated with N-2.1.1. Therefore, the first managed endpoint is assigned the identifier associated with N-2.1.

In another example, such as where the layered data structure 200 is an ordered list and/or where nodes are traversed and assessed sequentially, the stop criterion associated with a first node is based on the first managed endpoint satisfying the one or more conditional expressions associated with a first node, and traversal stops. The nodes are preferably arranged such that the most specific nodes are traversed before less specific nodes. For example, the default node would be traversed last to form the default base policy in the case that no conditional expressions associated with prior nodes are satisfied. Additionally or alternatively, the stop criterion is based on an earliest conditional expression satisfied approach, wherein the first managed endpoint is assigned to the node associated with the earliest/initial conditional expressions satisfied. Beneficially, this stop criterion allows for quick policy management rule assignment. Using the above example, the first managed endpoint is assigned an earlier node of N-2.

In a further example, the stop criterion is associated with no more subsequent nodes being available to traverse to and/or no more subsequent layers, which results in the system assigning the first managed endpoint the identifier associated with the default root node 204. Alternatively, the stop criterion is associated with the first managed endpoint satisfying the one or more conditional expressions of the initial node of the layered data structure or the final sequential node of the layered data structure. Optionally, the stop criterion involves time constraints or other boundary conditions. For example, the stop criterion is associated with the first managed endpoint satisfying one or more conditional expressions associated with the most recently traversed node within a predefined time period. E.g., method 300 repeats step 302 and 304 until the predefined time period is exceeded, at which point method 300 progresses to step 306. Timing out, wherein a predefined time limit is exceeded, is an error condition and the resolution is defined by standard error handling workflows and, dependent of the error handling workflows, any of the steps of method 300 are repeated.

Optionally, the identifier associated with a node of the one or more nodes of the layered data structure is assigned to multiple managed endpoints, wherein each node is associated with multiple managed endpoints. Preferably, the first managed endpoint of the multiple managed endpoints is associated with a single node of the one or more nodes, wherein each managed endpoint is associated with a single node.

Optionally, determining whether the first managed endpoint satisfies the stop criterion and assigning an identifier comprises one or more of the steps of method 400. Optionally, method 300 is repeated for one or more managed endpoints of a plurality of endpoints, wherein method 300 comprises at least step 610 of method 600.

Preferably, step 302 is followed by either step 304 or step 306. Optionally, step 304 is subsequently followed by step 306, such as when the first managed endpoint does not satisfy the stop criterion and is assigned the identifier associated with the default root node. Beneficially, the optional progression from step 304 to step 306 prevents infinite looping of step 302 and 304. For example, if the layered data structure is a tree traversed in reverse or an ordered list wherein the last subsequent node is the default root node, step 304 progresses to step 306.

Preferably, step 302 is performed by the first managed endpoint, such as by performing the steps 408, 410, and/or 412 of method 400, and steps 304 and 306 are optional. Alternatively, step 302 is performed by the server, a controlling endpoint such as a different managed endpoint to the first managed endpoint operated by an administrator of the enterprise system, or a control hub, such as control hub 1214 of FIG. 12.

Beneficially, method 300 results in the traversal of a layered data structure dependent on whether one or more managed endpoints satisfy a stop criterion. Method 300 is adaptable, as it can be used for any of the aforementioned example layered data structures or stop criteria. Additionally, method 300 is scalable, as method 300 can be used in targeting deployment of policy management rules and/or updates to a plurality of managed endpoints. The scalability is enhanced when method 300 is performed by the first managed endpoint, or a number of managed endpoints. By performing the method 300 at the endpoints increases to the number of managed endpoints does not require large increases in processing or storage resources of the server, as determining whether each managed endpoint satisfies a stop criterion is performed by each managed endpoint of the enterprise system. This also increases security as information associated with each managed endpoint does not need to be shared with the server.

FIG. 4 shows a flowchart illustrating a method for assigning an identifier to a first managed endpoint. Specifically, FIG. 4 illustrates a method 400 for using information associated with the first managed endpoint for assigning the identifier and is compatible with the processes of method 100, 300, 500, 600, 700, 800, 900, 1000, and/or 1100.

Method 400 is an example method based on using information associated with a first managed endpoint for assigning an identifier associated with a node within a layered data structure to the first managed endpoint, the method comprising steps 402, 404, and 406. Step 402 comprises receiving information associated with a first managed endpoint; step 404 comprises using the information associated with the first managed endpoint for determining whether the first managed endpoint satisfies one or more conditional expressions associated with a node; and step 406 comprises assigning an identifier associated with a node of a layered data structure to the first managed endpoint. Alternatively, or additionally, method 400 comprises steps 408, 410, and 412, and is performed at the first managed endpoint. Step 408 comprises receiving one or more sets of conditional expressions; step 410 comprises assessing whether the first managed endpoint satisfies a set of conditional expressions associated with a node of the layered data structure based on information associated with the first managed endpoint; step 412 comprises selecting a relevant set of conditional expressions, wherein the relevant set of conditional expressions is identified based on the stop criterion; and step 406 is optional.

Method 400 allows for targeted deployment of policy management rules based on requirements associated with specific managed endpoints. In a previous example in reference to stop criteria of method 300 in FIG. 3, it is determined whether the first managed endpoint satisfies the stop criterion for N-2.1. Information associated with the first managed endpoint is received, such as information associated with the conditions 202. The stop criterion for the present example requires determining that the first managed endpoint satisfies one or more conditional expressions associated with N-2.1 but does not satisfy one or more conditional expressions of any subsequent node. As the stop criterion for N-2.1 is met, the identifier associated with N-2.1 is assigned to the first managed endpoint.

In another example, also in reference to stop criteria of method 300 in FIG. 3, it is determined whether the first managed endpoint satisfies the stop criterion for N-2.1. Information associated with the first managed endpoint is available at the first managed endpoint, such as information associated with the conditions 202, and therefore step 402 is not required. The stop criterion for the present example requires determining that the first managed endpoint satisfies one or more conditional expressions associated with N-2.1 but does not satisfy one or more conditional expressions of any subsequent node. These conditional expressions, a set of conditional expressions associated with N-2.1 and a set of conditional expressions of a subsequent node, are received at the first managed endpoint. The set of conditional expressions associated with node N-2.1 are assessed at the first managed endpoint and the set of conditional expressions associated with a subsequent node are assessed at the first managed endpoint, and it is determined that the stop criterion for N-2.1 is met. The relevant set of conditional expressions is identified based on the stop criterion and, in this example, is identifies as the set of conditional expressions associated with N-2.1 as this is the last and/or only set satisfied by the first managed endpoint. The identifier associated with N-2.1 is optionally assigned to the first managed endpoint by the first managed endpoint, a server, or another device of the enterprise system. Alternatively, the first endpoint initiates deployment of the executable policy instructions associated with N-2.1 without an identifier associated with N-2.1 being assigned.

Information associated with the first managed endpoint of step 402 is received at the first managed endpoint, a different managed endpoint, and/or a server. Information associated with the first managed endpoint is received from the first managed endpoint, a server, an administrative system device, a controlling device such as a domain controller, and/or a different managed endpoint to the first managed endpoint. Information associated with the first managed endpoint comprises any of: policy identification information; assignment identification information; custom defined group information; defined group classification data; system information; hardware information; system health data; installed applications; and/or detected threats.

Step 404 comprises using the information associated with the first managed endpoint for determining whether the first managed endpoint satisfies one or more conditional expressions associated with a node. Step 404 is an optional step in determining whether the first managed endpoint satisfies a stop criterion, wherein the stop criterion is associated with the one or more conditional expressions associated with a node, and step 402 may be repeated for a plurality of nodes dependent on the stop criterion. For example, one of the one or more conditional expressions associated with a node may be based on the operating system version of the first managed endpoint, such as whether the first managed endpoint is using Windows 11 (RTM). Information associated with the first managed endpoint, such as the operating system installed on the first managed endpoint e.g. macOS Ventura (RTM), is used to determine whether the first managed endpoint would satisfy the conditional expression. In the present example, the first managed endpoint does not satisfy the conditional expression.

Step 406 comprises assigning an identifier associated with a node of the layered data structure to the first managed endpoint. Dependent on the stop criterion and/or whether the first managed endpoint satisfies the one or more conditional expressions, the node associated with the assigned identifier is the node associated with the one or more conditional expressions of step 404. Alternatively, the node associated with the assigned identifier is a different node, such as a parent/prior node or a child/subsequent node relative to the node associated with the one or more conditional expressions of step 404. In a first example, if satisfying a conditional expression associated with the node of step 404 (e.g. node labelled N-4.2 of FIG. 2) requires the first managed endpoint use Windows 11 (RTM) but the first managed endpoint uses macOS Ventura (RTM), the identifier associated with the prior node (e.g. node labelled N-4) is assigned to the first managed endpoint. In a second example, if satisfying a conditional expression associated with the node of step 404 (e.g. node labelled N-3) requires the first managed endpoint be communicatively coupled or otherwise connected to a specific peripheral device, such as an optical disk drive, and the first managed endpoint is connected to the specific peripheral device, the identifier associated with the node of step 404 (e.g. N-3) is assigned to the first managed endpoint. The first and second example represent different stop criteria.

Step 408 comprises receiving one or more sets of conditional expressions. Each set of the one or more sets of conditional expressions are associated with a node of the layered data structure, and comprise one or more conditional expressions. The one or more sets of conditional expressions are received from a server, a control hub such as control hub 1214 of FIG. 12, or another device of the enterprise system. For example, step 408 comprises receiving, from a server, one or more sets of conditional expressions associated with a layered data structure, wherein the layered data structure comprises a plurality of layers, each layer of the plurality of layers having one or more nodes, and wherein each node of the one or more nodes is associated with an identifier, one or more executable policy instructions, and a set of conditional expressions of the one or more sets of conditional expressions.

Step 410 comprises assessing whether the first managed endpoint satisfies a set of conditional expressions associated with a node based on information associated with the first managed endpoint. Optionally, step 410 is repeated when there is a change in the information associated with the first managed endpoint, such as a change in the user or the operation of the first managed endpoint. For example, step 410 comprises assessing whether the first managed endpoint satisfies a first set of conditional expressions associated with a first node based on information associated with the first managed endpoint.

Step 412 comprises selecting a relevant set of conditional expressions. The relevant set of conditional expression depends on the stop criterion. For example, the relevant set of conditional expressions is the first set of conditional expressions satisfied by the first managed endpoint, the last set of conditional expressions satisfied by the first managed endpoint, the penultimate set of conditional expressions satisfied by the first managed endpoint, or the first set of conditional expressions not satisfied by the first managed endpoint. In the event that there is not a stop criterion, selecting a relevant set of conditional expressions is performed in place of a stop criterion to determine one or more relevant executable policy instructions to be deployed to the first managed endpoint.

For example, step 412 comprises determining whether a stop criterion is met based on the assessment of step 410, wherein the stop criterion is associated with assessing whether the first managed endpoint satisfies a set of conditional expressions associated with a node of the one or more nodes. In the event the stop criterion is met, the first set of conditional expressions are identified as a relevant set of conditional expressions. In the event the stop criterion is not met, a subsequent set of conditional expressions associated with a subsequent node in the layered data structure are assessed until the stop criterion is met and the subsequent set of conditional expressions associated are identified as the relevant set of conditional expressions. The relevant set of conditional expressions is then selected wherein, based on the selection, the identifier of a relevant node associated with the relevant set of conditional expressions is assigned to the first managed endpoint. Optionally, step 412 further comprises initiating deployment of one or more relevant executable policy instructions to the first managed endpoint based on requesting one or more executable policy instructions associated with the identifier of the relevant node from the server.

Beneficially, method 400 allows for policy management rule implementation to be targeted at only the relevant managed endpoints, increasing efficiency, and prevents the need for deployment of executable policy instructions to managed endpoints that are not required to implement the executable policy instructions. Method 400 is adaptable, as it can be used for any of the aforementioned example layered data structures or stop criteria. Additionally, method 400 is scalable, as method 400 can be used in the assignment of identifiers, and therefore the targeting deployment of policy management rules and/or updates, to a plurality of managed endpoints.

FIG. 5 shows a flowchart illustrating a method for initiating deployment of executable policy instructions. Specifically, FIG. 4 illustrates a method 500 for deploying and/or outputting one or more executable policy instructions to a first managed endpoint based on an assigned identifier and is compatible with the processes of method 100, 300, 400, 600, 700, 800, 900, 1000, and/or 1100.

Method 500 is an example method for initiating selection-based deployment of specific executable policy instructions, based on node selection and/or identification of nodes based on managed endpoint selection, resulting in target deployment of policy management rules based on the selection of a node or managed endpoint.

Initiating deployment of policy management rule implementation is not limited to initiating deployment of all executable policy instructions to all managed endpoints within the enterprise system. Using method 500, deployment is initiated for one or more selected managed endpoints based on either direct managed endpoint selection and/or policy management rule selection via node selection and/or initiated by the first managed endpoint to receive relevant executable policy instructions for the first managed endpoint. Selection-based deployment allows for controlled, targeted deployment of selected executable policy instructions to specified managed endpoints without requiring mass deployment, improving both the efficiency and the security of using the layered data structure for the deployment of policy management rules.

Method 500 comprises step 502 and further comprises two processes, one based on node selection comprising steps 504 and steps 506, and one based on managed endpoint selection comprising steps 508 and 510.

Step 502 comprises initiating deployment of executable policy instructions to the first managed endpoint based on the assigned identifier; step 504 comprises receiving a node selection indicative of a specific node within the layered data structure; step 506 comprises deploying one or more executable policy instructions associated with the specific node based on an associated assigned identifier; step 508 comprises identifying a node associated with the assigned identifier; and step 510 comprises outputting one or more executable policy instructions associated with the identified node to the first managed endpoint.

Step 502 comprises initiating deployment of one or more executable policy instructions to a first managed endpoint based on an assigned identifier, such as the assigned identifier of step 406 of method 400, step 306 of method 300, and/or step 106 of method 100. Initiating deployment comprises outputting instructions for the deployment of one or more executable policy instructions, deploying one or more executable policy instructions, or otherwise starting a method and/or process that results in the deployment of one or more executable policy instructions. Step 502 is performed by the server, the first managed endpoint, or another device and/or component of the enterprise system.

Step 504 is an optional example step of a method resulting in the deployment of one or more executable policy instructions, preferably following from step 502. Step 504 comprises receiving a node selection indicative of a specific node within the layered data structure. For example, a node may be selected, such as the node labelled N-4 of layered data structure 200, and the node selection may be received at a server and/or the first managed endpoint and/or a different managed endpoint. The optional multiple receiving locations allows for server-based initiation of deployment to a managed endpoint and/or a managed endpoint-based initiation of deployment to a managed endpoint. This also allows for the initiation of deployment of relevant executable policy instructions to relevant managed endpoints, wherein only the executable policy instructions associated with selected node(s) are deployed to the managed endpoints associated with the selected node(s).

In one example, the node selection is based on a managed endpoint selection. One or more managed endpoints are selected, and each identifier assigned to the one or more selected managed endpoints is associated with one or more nodes of the layered data structure. Consequently, the selection indicates nodes associated with selected managed endpoints. In another example, the node selection is based on the selection of one or more conditions associated with one or more conditional expressions. The one or more conditional expressions are associated with one or more nodes, and therefore the selection indicates nodes associated with the selected conditions.

In another example, step 502 is performed by the first managed endpoint. The node selection received by the server in step 504 is the node selected and/or assigned to the first managed endpoint by the first managed endpoint, such as by using step 412 and/or step 406 of FIG. 4. For example, the first managed endpoint assesses one or more sets of conditional expressions from obtained from the server. The first managed endpoint selects a relevant set of conditional expressions associated to a relevant node. The first managed endpoint then initiates deployment of executable policy instructions by requesting, from the server, the executable policy instructions associated with the relevant node. The server receives the node selection indicative of the relevant node and subsequently performs step 506.

Step 506 comprises deploying one or more executable policy instructions associated with the specific node based on an associated assigned identifier. For example, if the node labelled N-4 was selected, the one or more executable policy instructions associated with the node labelled N-4 are deployed. In one example, the one or more executable policy instructions associated with the selected node are deployed to the one or more managed endpoints that are assigned the identifier associated with the selected node. In another example, the one or more executable policy instructions associated with the selected node are deployed to a chosen managed endpoint, wherein the chosen managed endpoint is selected by a server, a user, or a managed endpoint.

For example, a first managed endpoint assigned the identifier of a first node may request deployment of one or more executable policy instructions. E.g. the first managed endpoint may detect an update to executable policy instructions associated with the first node, there is a change of user associated with the first managed endpoint, and/or a predefined time period has passed since the first managed endpoint last received executable policy instructions. The server may receive a node selection indicating the first node from the first managed endpoint and deploy one or more executable policy instructions associated with the first node to the first managed endpoint.

Step 508 is an alternative example step of a method resulting in the output of one or more executable policy instructions, preferably following from step 502. Step 508 comprises identifying a node associated with the assigned identifier. Step 508 is used instead of step 504 when a node selection is not received, as required by step 504. For example, a managed endpoint is selected rather than a node, and the identifier assigned to the selected managed endpoint is associated with a node of the layered data structure. Consequently, selection of a managed endpoint identifies a node associated with the selected managed endpoints. In another example, initiating deployment of executable policy instructions was interrupted or otherwise terminated prematurely. A server or an enterprise system manager may reinitiate deployment based on the associated identifiers of executable policy instructions not yet deployed.

Step 510 comprises outputting one or more executable policy instructions associated with the identified node to the first managed endpoint. For example, executable policy instructions are output only to managed endpoints associated with user-selected or system-selected nodes. Beneficially, the process of step 510 allows for targeted deployment of executable policy instructions, such as for updated executable policy instructions (described in detail in reference to method 900 of FIG. 9).

Beneficially, method 500 allows for policy management rule implementation to be targeted at only the managed endpoint associated with one or more selected nodes. Beneficially, method 500 allows for targeted policy management deployment relevant to one or more selected managed endpoints. The selection-based deployment of method 500 increases efficiency, as it prevents the initiation of all executable policy instructions to all managed endpoints when only specific deployment is required, such as after an update to a managed endpoint or policy management rule. The selection-based deployment also prevents the need for deployment of executable policy instructions to managed endpoints that are not required to implement the executable policy instructions. Method 500 is adaptable, as it can be used for any of the aforementioned example layered data structures or stop criteria. Additionally, method 500 is scalable, as method 500 can be used for targeting deployment of policy management rules and/or updates, to a plurality of managed endpoints.

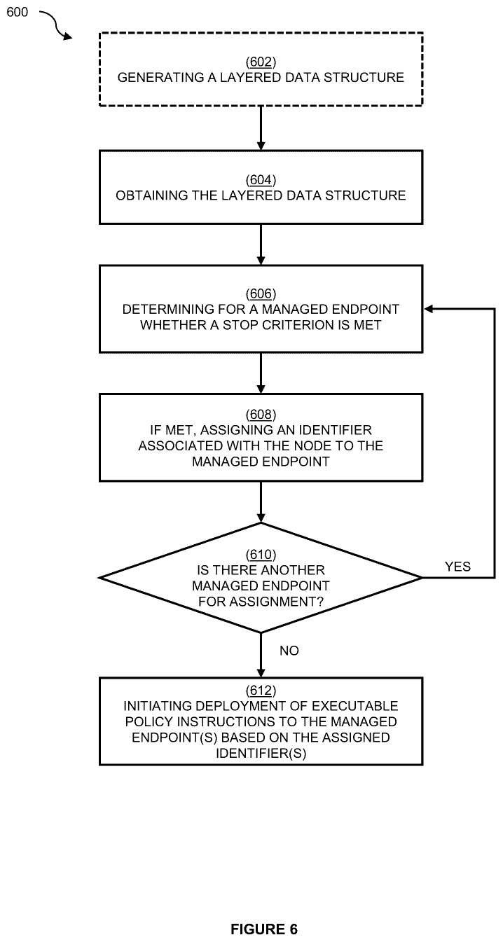

FIG. 6 shows a flowchart illustrating a method for deploying management rules for one or more managed endpoints. Specifically, FIG. 6 illustrates a method 600 for deploying and/or outputting one or more executable policy instructions to a first managed endpoint based on an assigned identifier and is compatible with the processes of method 100, 300, 400, 500, 700, 800, 900, 1000, and/or 1100.

Method 600 is an example method for targeted deployment of policy management rules to a plurality of managed endpoints based on a layered data structure. As mentioned above, enterprise systems can comprise anywhere from one managed endpoint to many dozens, many hundreds, or more. Therefore, time and computer resource efficient processes are required to assign policy management rules across the entire enterprise system. By determining whether another managed endpoint within the enterprise system requires assignment, method 600 allows for any number of assigned endpoints to be assigned policy management rules in an efficient and accurate process without unnecessary re-assignment. Beneficially, method 600 also allows for the assignment of policy management rules to be paused or otherwise interrupted and then resumed, and for managed endpoints newly introduced to the enterprise system to be assigned policy management rules efficiently, without requiring repeated assignment of previously assigned managed endpoints.

Method 600 comprises step 604, step 606, step 608, and step 610. Step 604 comprises obtaining a layered data structure. If the layered data structure has not yet been generated or cannot otherwise be obtained, method 600 further comprises step 602. Step 602 comprises generating a layered data structure. Step 606 comprises determining, for a managed endpoint, whether a stop criterion is met. Step 608 comprises, if met, assigning an identifier associated with the node to the managed endpoint. Step 610 comprises determining if there is another managed endpoint for assignment. Step 612 comprises initiating deployment of executable policy instructions to the managed endpoint(s) based on the assigned identifier(s).

Step 602 comprises generating a layered data structure, such as layered data structure 200, for example using at least in part the processes of method 700 or 800. The process of step 602 is optional, as the layered data structure may be pre-generated, stored, or otherwise obtained.

Step 604 comprises obtaining the layered data structure. The obtained layered data structure is the layered data structure generated in step 602 or an already created layered data structure. For example, the layered data structure is obtained from a server, such as a cloud server or a local server. Optionally, obtaining the layered data structure further comprises any of: evaluating and/or analyzing the layered data structure, assessing the layered data structure for conflicts, resolving any assessed conflicts, or rendering the layered data structure.

Step 606 comprises determining, for a managed endpoint, whether a stop criterion is met, e.g. step 302 of method 300 or step 104 of method 100. For example, at a first node (e.g. node N-1 of layered data structure 200), a first managed endpoint may or may not satisfy the stop criterion, which is associated with whether the first managed endpoint satisfies one or more conditional expressions associated with the first node. If the stop criterion is met, the method progresses to step 608. Preferably, step 606 is performed at the first managed endpoint. Alternatively, step 606 is performed at the server or a different device and/or component of the enterprise system.

Step 608 comprises assigning an identifier associated with the node to the managed endpoint, e.g. step 406 of method 400, step 306 of method 300, or step 106 of method 100. For example, the identifier associated with the first node is assigned to the first managed endpoint.

Step 610 is optional and comprises determining whether there is another managed endpoint for assignment. For example, the first managed endpoint may be a first managed endpoint of a plurality of managed endpoints, wherein the plurality of managed endpoints further comprises a second managed endpoint. Each managed endpoint of the plurality of managed endpoints is assigned an identifier or a subset of one or more selected managed endpoints of the plurality of endpoints are assigned an identifier. For example, the subset may be one or more managed endpoints that are not currently assigned an identifier, e.g. if the second managed endpoint is not assigned an identifier associated with a node of the layered data structure, then it is determined that there is another managed endpoint for assignment.

If it is determined that there is another managed endpoint for assignment, the process moves to step 606, which is then repeated. For example, it is determined whether, for the second managed endpoint, whether the stop criterion, which is associated with whether the second managed endpoint satisfies one or more conditional expressions associated with the first node. If it is determined that there is not another managed endpoint for assignment, the method progresses to step 612. Preferably, steps 606, 608 and 612 are performed in parallel for a plurality of managed endpoints in the enterprise system. For example, a first managed endpoint determines whether a stop criterion is met based on assessing whether a set of conditional expressions is met by the first managed endpoint. Simultaneously, a second managed endpoint determined whether the stop criterion is met based on assessing whether a set of conditional expressions is met by the second managed endpoint. Beneficially, this results in fast and resource-efficient mapping of managed endpoints to relevant policy rules, and hence more effective deployment of executable policy instructions. Alternatively, step 612 can be performed in parallel to repeated steps 606-610, wherein deployment of executable policy instructions is completed sequentially as method 600 repeats for each managed endpoint requiring assignment. Sequential-based initiation of deployment can increase the efficiency while batch-based initiation of deployment can be beneficial for, for example, scheduled deployment.

Step 612 comprises initiating deployment of one or more executable policy instructions to the one or more managed endpoints based on the one or more assigned identifiers. For example, if both the first managed endpoint and the second managed endpoint are assigned the identifier associated with the first node, deployment is initiated of the one or more executable policy instructions associated with the first node to the first managed endpoint and the second managed endpoint. Initiating deployment comprises execution of the one or more executable policy instructions associated with the first node at the first managed endpoint or the second managed endpoint or receiving a request for the one or more executable policy instructions. Optionally, step 612 is any of the steps of method 500 or step 108 of method 100.

Beneficially, method 600 is scalable, as it allows for the target deployment of policy management rules to any number of managed endpoints within the enterprise system. Additionally, method 600 is an example process for increasing the adaptability of the policy management system, as step 610 may be incorporated into any of the methods described herein, with any steps repeated where required based on the determination that there is another managed endpoint.

Methods 700-800 of FIGS. 7-8 are directed towards the organization or policy management rules for targeted deployment.

FIG. 7 shows a flowchart illustrating a method for organizing policy management rules based on generating a layered data structure. Specifically, FIG. 7 illustrates a method 700 for generating a layered data structure, which is compatible with the processes of method 100, 300, 400, 500, 600, 800, 900, 1000, and/or 1100.

Method 700 represents a process for generating a layered data structure based on a received set of control statements. As previously mentioned, control statements can be received from a variety of sources and contain different formats and purposes. Transforming the control statements into a single set of conditional expressions results in policy management rules that follow a shared format, making the policy and assignment rules casily understood and analyzed, and more efficiently processed. Additionally, generating a layered data structure using the conditional expressions allows for the organization and targeted deployment of policy management rules.

Method 700 comprises step 702, step 704, step 706, and step 708. Step 702 comprises receiving a first set of control statements; step 603 comprises transforming the first set of control statements into a first set of conditional expressions; step 706 comprises generating a layered data structure comprising a plurality of layers; and step 708 comprises initiating distribution of one or more executable policy instructions to a first managed endpoint based on the layered data structure.

For example, a first set of control statements associated with policy management control are received from enterprise system controllers and policy management specialists. These are then transformed into a first set of conditional expressions, such as based on conditions 202 of FIG. 2. A layered data structure is then generated wherein the first set of conditional expressions are structured into one or more nodes across a plurality of layers, such as layered data structure 200 of FIG. 2. Distribution of one or more executable policy instructions associated with the conditional expressions to a first managed endpoint can then be initiated, wherein the specific executable policy instructions deployed to the first managed endpoint is based on the layered data structure using any of the aforementioned methods.

Step 702 comprises receiving a first set of control statements from one or more sources, wherein the first set of control statements are associated with policy management rules. The first set of control statements are received at a server, such as a cloud server or a local server, and/or a computing system, such as policy management system 1200.

Step 704 comprises transforming the first set of control statements into a first set of conditional expressions. Transformation takes place at the same system and/or server as step 702 or another system and/or server that is configured to communicate with the system and/or server of step 702. The process of transforming is based on predefined criteria, and the first set of conditional expressions are associated with properties of one or more managed endpoints. In one example, transforming the first set of control statements may comprise any of the steps of method 800 of FIG. 8. For example, information is extracted from the first set of control statements and ordered based on conditions 202 of FIG. 2.

In one example, a first set of control statements comprises a first policy statement, indicating that peripheral devices are blocked to prevent unauthorized extraction of sensitive data, a second policy statement, indicating that peripheral devices are allowed for the technical support team for testing equipment, and a third policy statement, indicating that a specific peripheral device, a monitor, is allowed for the software development team in the London office, where blocking second devices interferes with testing environments. A first set of conditional expressions includes conditions relating to the department, such as the technical support team or the software development team, and the location, such as the London office.

Step 706 comprises generating a layered data structure comprising a plurality of layers, wherein each layer of the plurality of layers has one or more nodes. Each node of the one or more nodes (e.g. leaf node 206 of FIG. 2) is associated with an identifier, one or more conditional expressions of the first set of conditional expressions, and one or more executable policy instructions. The one or more executable policy instructions represent executable code for implementation on the one or more managed endpoints.

Following from the above example in reference to step 704, the layered data structure is a decision tree and comprises: a default root node associated with executable policy instructions for implementing the first policy statement regarding blocking peripherals; a first condition regarding department; a second condition regarding location; a first layer comprising a first leaf node associated with the first condition and associated with executable policy instructions for allowing peripheral devices; and a second layer comprising a first continuation node associated with the first condition and a second leaf node associated with the second condition and associated with executable policy instructions for allowing a peripheral monitor. A managed endpoint used by the technical support team satisfies the conditional expression associated with the first leaf node. A managed endpoint used by the software development team in the London office satisfies the conditional expressions associated with the second leaf node.

Step 708 comprises initiating distribution of the one or more executable policy instructions to a first managed endpoint based on the layered data structure. Following from the above example in reference to step 706, executable policy instructions associated with the first leaf node are deployed to the managed endpoint used by the technical support team and executable and executable policy instructions associated with the second leaf node are deployed to the managed endpoint used by the software development team in the London office.

Optionally, step 708 comprises outputting the layered data structure, such as from a cloud server to a local server, and/or deploying one or more executable instructions associated with the layered data structure to one or more managed endpoints. Additionally or alternatively, step 708 comprises organizing the distribution of the one or more executable instructions to one or more managed endpoints, such as by using the layered data structure, with or without initiating deployment of the one or more executable instructions to the one or more managed endpoints.

Optionally, step 708 comprises the processes of one or more of method 100, method 300, method 400, method 500, method 600, and/or method 900. Beneficially, as the first set of control statements are collectively transformed into a first set of control statements using the same conditions, method 700 helps prevent the creation of superfluous, even conflicting, system control instructions and unifies policy control potentially from multiple different sources. It also decreases redundancy by not only preventing duplications, but also by streamlining the control statements into easily understandable, and optionally machine readable, conditional expressions. Compiling multiple control statements at a server allows for efficient detection of conflicting or overlapping policies, while initiating deployment can be performed by a local hub and/or managed endpoint, resulting in policy ruleset assessment performed locally.

FIG. 8 shows a flowchart illustrating a method for transforming control statements into conditional expressions. Specifically, FIG. 8 illustrates a method 800 for transforming a set of control statements into conditional expressions, which can then be used in generating a layered data structure, e.g. layered data structure 200 of FIG. 2, and is compatible with the processes of method 100, 300, 400, 500, 600, 700, 900, 1000, and/or 1100.

As previously mentioned, control statements can be received from a variety of sources and contain different formats and purposes and transforming the control statements into a single set of conditional expressions results in policy management rules that follow a shared format. Beneficially, the transformed set of conditional expressions result in the policy and assignment rules being presented in an easily understood format, increasing the efficiency and accuracy of processing and analysis of the policy management rules. Method 800 represents a process for performing the transformation of control statements, beneficially: increasing the efficiency and accuracy of the layered data structure by increasing the uniformity of the control statements; increasing the ability to process, analyze, and prioritize the policy management rules; and making the detection of duplicate, superfluous, or conflicting policy management rules easier and more efficient.

Method 800 is an example method for the transformation of a first set of control statements into a first set of conditional expressions, e.g. step 802, based on structure and predefined criteria. Method 800 comprises any of step 804, step 806, step 808, and/or step 810. Step 804 comprises structuring the first set of control statements based on predefined criteria; step 806 comprises forming a table based on the predefined criteria; step 808 comprises ordering the first set of control statements based on a determined priority; and step 810 comprises generating the first set of conditional expressions based on the structured first set of control statements.

Step 802 comprises transforming a first set of control statements into a first set of conditional expressions. Transformation takes place at a system and/or server and, optionally, is step 704 of method 700. The process of transforming is based on predefined criteria, and the first set of conditional expressions are associated with properties of one or more managed endpoints, such as conditions 202 of FIG. 2. The process of step 802 includes extracting information from the first set of control statements regarding one or more conditions that can be unique, wherein a different condition is extracted from each control statement, or shared, wherein at least one condition is shared from two or more control statements.

Step 804 is an optional step comprising structuring the first set of control statements based on predefined criteria. Optionally, structuring the control statements comprises extracting key datapoints, such as system-relevant, policy-relevant, user-relevant or managed-endpoint relevant conditions.

For example, a first set of control statements is received from multiple sources and structured in the form of a list: all peripheral devices must be blocked by default to prevent unauthorized extraction of sensitive data; peripheral optical disk drives are allowed for user identifiers associated with system engineers to transfer information but monitored for sensitive data protection; peripheral devices are allowed for the technical support team for testing equipment; monitors are allowed for the software development team in the London office, as blocking monitors interferes with the testing environments. Key datapoints relate to the department, such as the technical support team, and the location, such as the London office, and the user identifier, such as system engineers, as well as peripheral devices including optical disk drives and monitors.

Step 806 is an optional step comprising forming a table based on predefined criteria. For example, relevant information is extracted from the first set of control statements and tabulated based on headings that are set by the predefined criteria. This results in a human and machine readable format for ordering, storing, and using the relevant information of the first set of control statements.

Following on from the above example in reference to step 804, a table based on the predefined criteria of “effected entities”, “policy”, and “reasoning”:

| Policy | | | |
|---|---|---|---|
| Identifier | Effected Entities | Policy | Reasoning |
| PID-1 | All (default) | All peripheral | Preventing |
| | | devices are blocked | unauthorized |
| | | | extraction of |
| | | | sensitive data |
| PID-2 | User identifier - | Peripheral optical | Safe local |
| | system engineers | disk drives allowed | information |
| | | | transfer |
| | | | required - |
| | | | Approved |
| PID-3 | Department - | All Peripheral | Equipment |
| | technical | devices are allowed | testing |
| | support team | | required - |
| | | | Approved |
| PID-4 | Department - | Monitor only | Blocking |
| | software | allowed | monitor |
| | development team; | | interferes |
| | AND Location - | | with test |
| | London | | environments |

Step 808 is an optional step comprising ordering the first set of control statements based on a determined priority. For example, the first set of control statements are ordered from highest priority to lowest priority. Beneficially, the process of step 808 allows for efficient rectification of detected conflicts or overlapping policies. In another example, an identifier associated with each control statement, such that each control statement has a unique identifier, is generated based on the priority order of the control statement. The determined priority is based on any of the predefined criteria, the number of managed endpoints effected by the control statement, predefined priority criteria e.g. based on the users associated with one or more managed endpoints, and/or server-generated priority criteria e.g. based on one or more security implications.

Following on from the above example in reference to step 806, the policies are ordered with highest priority at the top:

| | Policy | |
|---|---|---|
| Priority | Identifier | Comment |
| 3 | PID-3 | Use of peripheral devices is not blocked nor |
| | | monitored |
| 2 | PID-2 | Use of peripheral optical disk drives not |
| | | blocked but monitored |
| 1 | PID-4 | Use of monitor allowed |
| 0 | PID-1 | All peripheral devices are blocked as default |

Step 810 is an optional step comprising generating the first set of conditional expressions based on the structured first set of control statements. For example, device data attributes associated with the first set of control statements are identified, such as operating system name and versions or the device purpose, wherein the device is a managed endpoint. Device data attributes are used to form rule determinants, wherein rule determinants are Boolean expressions defining matching data attributes. The first set of conditional expressions are represented by formulating the rule determinants with the structured first set of control statements. Optionally, the first set of conditional expressions are used in generating a layered data structure, such as layered data structure 200, e.g. using method 700.

Following on from the above example in reference to step 808, the first set of conditional expressions are associated with the following conditions:

| Policy | | |
|---|---|---|
| Management | | |
| Rule | Conditions | Assigned policy |
| R3 | Department(technical support team) | PID-3 |
| R2 | User(system engineer) | PID-2 (Monitor) |
| R1 | Department(software development | PID-4 |
| | team) AND Location(London) | |
| R0 | None | PID-1 |

The example condition for Location (London) characterizes a data expression, wherein the data expression represents the condition that the location of the first managed endpoint must be in London to satisfy the condition.

Optionally, predefined criteria comprise any of: where the control statement is applicable or to whom, such as a department, geographical location, or predefined subset of one or more managed endpoints; what is needed to satisfy conditions associated with the control statement, such as peripheral devices associated with the one or more managed endpoints; and/or information related to the control statement, such as why the control statement is applied, when the control statement was made, or who the control statement was made by.

One alternative or additional step to step 806 comprises listing the control statements.

Beneficially, as the first set of control statements are transformed into a first set of control statements based on predefined criteria, method 800 prevents the creation of superfluous system control instructions and unifies policy control potentially from multiple different sources. Method 800 also allows for early and accurate conflict detection based on the structured first set of control statements. It also decreases redundancy by not only preventing duplications, but also by streamlining the control statements into easily understandable, and optionally machine readable, conditional expressions. Method 800 is adaptable, as any of steps 804-810 can be included and/or excluded, allowing for method 800 to be tailored to the first set of control statements received by the server.

Following on from the above example in reference to step 810, a layered data structure generated in a tabular format is represented as:

| Layer | Department | User | Location |
|---|---|---|---|
| N-0 | | | |
| (R0/PID-1) | | | |
| L1 | N-1 (R3/PID-3) | | |
| | Department(technical | | |
| | support team) | | |
| L2 | | N-2 (R2/PID-2) | |
| | | User(system | |
| | | engineer) | |
| L3 | N-3 | | N-3.1 |
| | Department(software | | (R1/PID-4) |
| | development team) | | Location(London) |

In the present example, the layered data structure is generated using the processes of method 700. N-0 is a default node associated with the conditions of policy management rule R0 and the implementation of PID-1; N-1 is a first node associated with the condition of policy management rule R3 and the implementation of PID-3; N-2 is a second node associated with the condition of policy management rule R2 and the implementation of PID-2; N-3 is a third node associated with the first condition but not the second condition of policy management rule R1; and N-3.1 is a fourth node associated with both the first and the second condition of policy management rule R1 and the implementation of PID-4.

The tabular layered data structure is traversed from left to right and top to bottom using the process of method 300, and the stop criterion is based on a last condition satisfied approach. For example, the stop criterion for N-3.1 requires that the conditions for N-3 and N-3.1 are met but that the conditions of any subsequent nodes are not met. In situations where there are no subsequent nodes but the conditions of the current node is met, the stop criterion is satisfied.

Formatted as an ordered list, the layered data structure is:

| Ordered | | Policy | Node |
|---|---|---|---|
| List ID | Condition | Identifier | Identifier |
| OL1 | Department(technical | PID-3 | N-1 |
| | support team) | | |
| OL2 | User(system engineer) | PID-2 | N-2 |
| OL3 | Department(software | PID-4 | N-3.1 |
| | development team) AND | | |
| | Location(London) | | |
| OLMAX | None | PID-1 | N-0 |

The ordered list layered data structure is also traversed from top to bottom using the process of method 300, but the stop criterion is based on a first condition satisfied approach. Therefore, the default node is at the bottom of the list, unlike for the tabular layered data structure. For example, the stop criterion for OLI requires that the conditions for OLI are met with no further stipulations.

Methods 900-1100 are directed towards changes, preferable to small changes, to one or more aspects of existing policy represented by the layered data structure. Patches are typically small modifications to existing policies as opposed to newly created policy management rules. By applying patches, methods 900-1100 help avoid the need to materialize all minor policy changes to one or more policies, therefore avoiding policy proliferation, which is the use of high number of policies with small differences between each other. Additionally, methods 900-1100 allows for significantly similar policies to be pruned, as shown regarding layered data structure 200 of FIG. 2, without impacting the implementation of small modifications made to existing policies. Patch conditions can be evaluated at a server or at a managed endpoint, and a list of patch identifiers can be produced indicative of which patches need to be deployed to, and implemented at, the managed endpoint.

Additionally, while user-based policy assignment rules can be added as extra layers to the device-based rule tree such as layered data structure 200, the additional user-based layers approach will cause drastic increase in the number of nodes and branches and/or to the number of entries in the layered data structure. The increase can cause serious usability issues with management of the rules. Methods 900-1100 allow for the use of the device-based rules to determine the base policy to apply to the managed endpoint, and then apply any additional policy implementations mapped to the user-based rules as patches on top of the base policy. A patch can override executable policy instructions of the base policy or be in addition to the executable policy instructions of the base policy.

For example, patch changes are not applied to base policies to generate materialized modified policies and instead the conditions of all patches to a policy are evaluated against information associated with the managed endpoint and user identifier to determine the list of applicable patch identifiers. The patches are subsequently deployed to the managed endpoint and implemented, modifying the base policy. Optionally, a patch can have additional conditions based on policy management rules which render the patch modification incompatible and/or meaningless.

Additionally or alternatively, patches are mapped to any policy management rule conditions regarding either the managed endpoint or user identifier. For example, a first conditional expression is formed from transforming two control statements, resulting in a first executable policy instruction implemented at a first managed endpoint. Alternatively, a conditional expression is formed from transforming one control statement, resulting in a second executable policy instruction implemented at the first managed endpoint, and the other control statement instead is used to generate an executable patch instruction for implementation alongside the second executable policy instruction at the first managed endpoint.

Beneficially, methods 900-1100 result in increased adaptability, as small changes in policy do not result in policy proliferation. Additionally, updates to policy assignment can be initiated from a managed endpoint, a local hub, a system controller such as from a security specialist for the enterprise network, or at a server, which improves adaptability and both the efficiency and security of the enterprise system.

FIG. 9 shows a flowchart illustrating a method for distributing updated policy instructions. Specifically, FIG. 9 illustrates a method 900 initiating deployment of executable patch instructions based on updated policy instructions, and is compatible with the processes of method 100, 300, 400, 500, 600, 700, 800, 1000, and/or 1100.

Method 900 represents a process for initiating targeted deployment of an updated patch instruction to a relevant managed endpoint based on an updated policy instruction. Changes, preferably small changes, to existing policy are identified and patches representing the changes are generated. The executable patch instructions are applied at the point of use, a managed endpoint, and therefore method 900 addresses the problem of policy proliferation.

The patches are associated with conditions defining the applicability of the patch for both a first managed endpoint and user identifier. A patch may also be associated with a condition defining the applicability of the patch in combination with specific policy settings such as disabling a protection in the policy. For example, a first executable patch instruction represents a policy modification applicable only when a user identifier, associated with a logged on user of the first managed endpoint, is an Administrator. The first executable patch instruction results in, for example, an override of security limitations implemented on the first managed endpoint under a base policy, such as a previously deployed executable policy instruction.

Additionally, if there are several patches they can be consolidated and merged to the main base policies. For example, an enterprise system engineer does not have access rights to change base policies but has access rights to apply patches to existing policies on demand. Policy administrators or a more senior enterprise system engineer who have the rights to edit policies then review the patches and can determine whether to merge some of them in the main policies. For example, if it is found that most people from a Marketing department in a particular location have been granted access to USB memory sticks, it may be more efficient to delete all relevant patches regarding USB access and instead create a new main policy for the marketing department which extends the existing policy for the marketing department in that location policy to grant USB access. This rule is then cleaned and assigned to the relevant marketing computers at the location based on the method disclosed herein. Such an example is non-limiting and the skilled person will realize that the described principles can be applied to various situations as required.

Method 900 comprises step 902, step 904, step 906, step 908, step 910, and step 912. Step 902 comprises obtained a layered data structure; step 904 comprises identifying a change to a first policy instruction; step 906 comprises generating an executable patch instruction; step 908 comprises determining whether a first managed endpoint is affected by the change to the first policy instruction; step 910 comprises, if affected, assigning an identifier to the first managed endpoint; and step 912 comprises initiating deployment of the executable patch instruction based on the assigned identifier.

Step 902 comprises obtaining a layered data structure at a server, such as a cloud server or a local server. The layered data structure comprises a plurality of layers, wherein each layer comprises one or more nodes. Each node is associated with an identifier, one or more conditional expressions of a first set of conditional expressions, such as the first set of conditional expressions generated in step 810 of method 800, and one or more executable policy instructions.

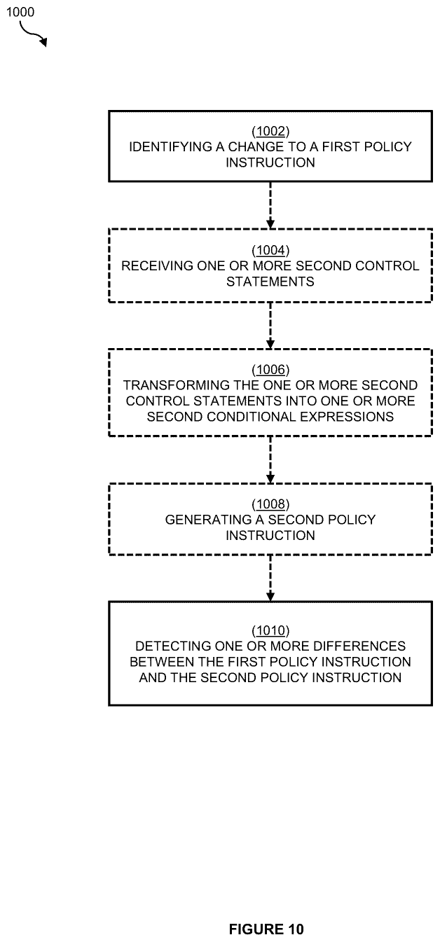

Step 904 comprises identifying a change to a first policy instruction associated with the one or more executable policy instructions. For example, step 904 further comprises method 1000 of FIG. 10. Identifying a change is performed by one or more managed endpoints, a server, or another device and/or system such as policy management system 1200 of FIG. 12. The change represents a change in how the one or more executable policy instructions associated with one or more control statements are applied to the one or more managed endpoints. For example, a change represents an update to an existing executable policy instruction or a new executable policy instruction. In another example, a change represents an update to a control statement and/or conditional expression. The change may encompass a plurality of changes. Optionally, identifying a change to the first policy instruction further comprises obtaining a second policy instruction and detecting one or more differences between the first policy instruction and the second policy instruction.

Step 906 comprises generating an executable patch instruction, wherein the executable patch instruction represents the change to the first policy instruction. The executable patch instruction is an update to at least one of the one or more executable policy instructions, a replacement to an existing executable policy instruction, and/or an additional executable policy instruction, such as a patch update. For example, the executable patch instruction comprises instructions that, when executed on a first managed endpoint, result in the first managed endpoint applying a representation of the change to the first policy instruction.

For example, the first policy instruction comprises a condition associated with a peripheral optical disk drive, due to a security risk associated with peripheral optical disk drives. The first policy instruction is then updated wherein the condition is associated with a specific peripheral optical disk drive, such as a Blu-ray drive, due to the security risk associated with all other peripheral optical disk drives being resolved while the risk from Blu-ray drives specifically is outstanding. The executable patch instruction comprises instructions to not execute a previous executable policy instruction associated with the original first policy instruction if the first managed endpoint does not satisfy the new condition.

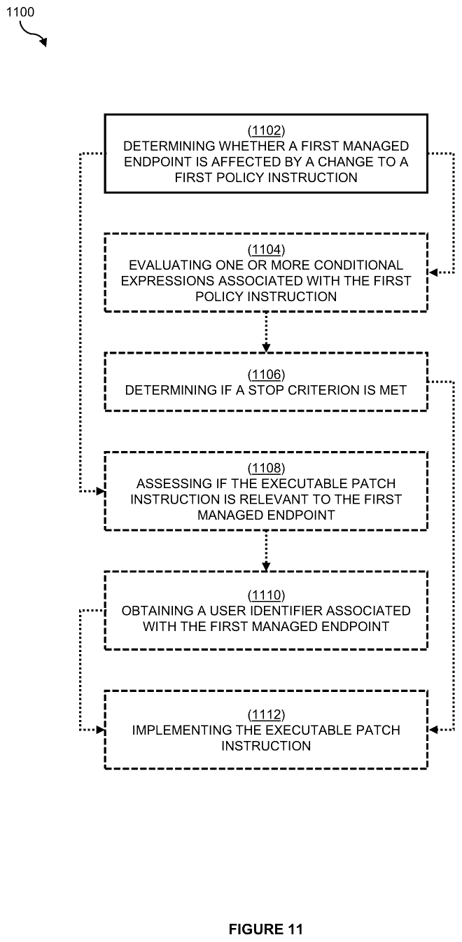

Step 908 comprises determining whether a first managed endpoint of the one or more managed endpoints is affected by the change to the first policy instruction. For example, step 908 further comprises any of the steps of method 1100 of FIG. 11. The first managed endpoint is affected if, for example, one or more executable policy instructions associated with the first policy instruction were implemented at the first managed endpoint, and/or the first managed endpoint requests or otherwise initiates a request for the executable patch instruction, and/or the first managed endpoint satisfies one or more conditional expressions associated with the first policy instruction or the executable patch instruction. If the first managed endpoint is determined to be affected, the method progresses to step 910.

Alternatively, step 908 comprises determining whether a first managed endpoint of the one or more managed endpoints is affected by a change to the first managed endpoint, a user of the first managed endpoint, a hardware requirement of the first managed endpoint, a software requirement of the first managed endpoint, or another change to the operation and/or use of the first managed endpoint. For example, if a change to the operation of the first managed endpoint is detected, say the first managed endpoint detects a new portable USB drive and an associated request from the user of the first managed endpoint to access the portable USB drive. The first managed endpoint transmits the request to an authoriser, wherein the authoriser preferably initiates step 904 and/or step 906. The authoriser is an automated process comprised within the server or a manual process performed at a controlling endpoint, such as a managed endpoint operated by an administrator of the enterprise system.

Step 910 comprises assigning the identifier associated with a first node of the one or more nodes to the first managed endpoint. For example, the change in the first policy instruction is associated with the first node, which is associated with an identifier, and the first managed endpoint is assigned the identifier associated with the first node if the first managed endpoint is affected by the change in the first policy instruction. Assigning can be performed at a server a managed endpoint such as the first managed endpoint. Further detail is described in reference to step 608 of method 600, step 406 of method 400, step 306 of method 300, and/or step 106 of method 100.

Step 912 comprises initiating deployment of the executable patch instruction to the first managed endpoint based on the assigned identifier. If there are a plurality of executable patch instructions representing a plurality of changes to one or more policy instructions, step 912 is repeated for each executable patch instruction of the plurality of executable patch instructions. Initiating deployment may be performed by a server or a managed endpoint such as the first managed endpoint. For example, a first executable patch instruction associated with the first node is deployed to the first managed endpoint assigned the identifier associated with the first node, and a second executable patch instruction associated with a second node is deployed to a second managed endpoint assigned the identifier associated with the second node.

Where an executable patch instruction is not associated with a node, step 902, step 910 and step 912 are optional. For example, in a situation where the authoriser initiates step 904 and/or step 906 in response to the first managed endpoint detection a change to the first managed endpoint in step 908, the authoriser initiates generation of an executable patch instruction. The executable patch instruction is deployed from the server or from a managed endpoint associated with the authoriser, such as the first managed endpoint or the controlling endpoint, directly. In the example of detecting a portable USB drive, the executable patch instruction comprises instructions that, once performed by the first managed endpoint, allow the user of the first managed endpoint to access the portable USB drive. The executable patch instruction is mapped to a node associated with a first policy instruction to block access to portable USB drives automatically or after receiving confirmation from the authoriser. Beneficially, a new policy instruction for each permanent or temporary access request is not required, preventing the proliferation of policies, nodes and/or policy management rules.

Optionally, step 908 is not required if all managed endpoints of a plurality of managed endpoints are determined to be affected. Alternatively, one or more managed endpoints are determined to be affected by the change to the first policy instruction based on previously being deployed one or more executable policy instructions. Alternatively, one or more managed endpoints is determined to be affected by user-selection. Optionally, if there is a second managed endpoint, step 908 is repeated for the second managed endpoint.

Optionally, the one or more executable patch instructions are associated with one or more conditions defining the applicability of the patch for any of a specific managed endpoint or a user context (e.g. a change in the first policy instruction is applicable only when the first managed endpoint is accessed by a first user and/or first user identifier, such as a security analyst). Additionally or alternatively, the one or more executable patch instructions are associated with one or more conditions defining the applicability of the one or more executable patch instruction in combination with specific requirements associated with one or more conditional expressions (e.g. a protection is disabled in the policy).

Beneficially, the executable patch instruction can be applied at the point of use, such as via a user interface and/or at a managed endpoint. Methods 900-1100 also address the problem of policy proliferation, as one or more executable patch instructions can be deployed in place of generating a plurality of new nodes, many with similar executable policy instructions. Preventing proliferation increases efficiency and understandability, reducing the complexity of the layered data structure and the amount of computational resources required in generating, evaluating, rendering, or otherwise operating a policy management system.

FIG. 10 shows a flowchart illustrating a method for identifying a change to a policy instruction. Specifically, FIG. 10 illustrates a method 1000 detecting a difference between a first policy instruction and a second policy instruction and is compatible with the processes of method 100, 300, 400, 500, 600, 700, 800, 900, and/or 1100.

Method 1000 is a process for identifying a change in a policy instruction based on detecting a difference between a first policy instruction and a second policy instruction. Detecting the difference between a first and a second policy instruction allows for significantly similar policies to be pruned without impacting the implementation of both policy instructions. The resultant patch implementation based on the difference between policies avoids the need to materialize all minor policy changes to one or more policies, therefore avoiding policy proliferation.

Method 1000 comprises step 1002 and step 1010, and optionally comprises step 1004, step 1006, and/or step 1008. Step 1002 comprises identifying a change to a first policy instruction; step 1004 comprises receiving one or more second control statements; step 1006 comprises transforming the one or more second control statements into one or more second conditional expressions; step 1008 comprises generating a second policy instruction; and step 1010 comprises detecting one or more differences between the first policy instruction and the second policy instruction.

Step 1002 comprises identifying a change to a first policy instruction, which is compatible with step 904 of method 900. Optionally, identifying the change comprises obtaining a second policy instruction, wherein the second policy instruction is an updated version of the first policy instruction or otherwise associated with the first policy instruction, and the method progresses to step 1010. Alternatively, the method progresses to step 1004.

Step 1004 is an optional step comprising receiving, at a server, one or more second control statements. For example, the second control statements are associated with policy management rules and are different or otherwise updated versions of the first set of control statements used to generate the layered data structure associated with the first policy instruction.

Following on from the above example in reference to step 906 of method 900, the first policy instruction comprises a condition associated with a peripheral optical disk drive. A second control statement is received indicative of a change in the security risk associated with peripheral optical disk drives but the maintained security risk of peripheral Blu-ray drives.

Step 1006 is an optional step comprising transforming the one or more second control statements into one or more second conditional expressions based on predefined criteria, such as using the process described in method 800. Following on from the above example in reference to step 1004, the second control statement is transformed into a second conditional expressions based on a condition associated with whether there is a peripheral optical disk drive and whether the peripheral optical disk drive is a Blu-ray drive. Optionally, the one or more second conditional expressions are associated with classifying one or more managed endpoints.

Step 1008 is an optional step comprising generating the second policy instruction, wherein the second policy instruction is associated with the one or more second conditional expressions. Following on from the above example in reference to step 1006, the second policy instruction represents an updated first policy instruction forms, and comprises a condition associated with a Blu-ray drive specifically. Optionally, the second policy instruction is one or more executable policy instructions.

Step 1010 comprises detecting one or more differences between the first policy instruction and the second policy instruction. Step 1010 is performed using known computational methods, such as: a text comparison between the first policy instruction and the second policy instruction wherein both policy instructions are formatted as strings; comparing extracted and/or encoded information from the first policy instruction and the second policy instruction; or using data associated with version history/modification tracking. Following on from the above example in reference to step 1008, the difference between the first policy instruction and the second policy instruction is that, after the change, only peripheral Blu-ray drives specifically are not allowed. An example resulting executable patch instruction comprises instructions to not execute a previous executable policy instruction associated with a peripheral optical disk drive if the first managed endpoint does not satisfy the new condition associated with being connected to a peripheral Blu-ray drive.

One or more detected differences between the first policy instruction and the second policy instruction is represented by the change to the first policy instruction. For example, one or more differences comprise any of: a different condition associated with the first policy instruction and the second policy instruction, such as a difference between a first conditional expression and a second conditional expression; a difference in the executable script associated with implementing the first policy instruction, such as a difference between a first executable policy instruction and a second executable policy instruction; and/or a difference in the predefined criteria associated with the first policy instruction, e.g. the predefined criteria of step 806.

If the second policy instruction is not associated with the first policy instruction or the differences between the second policy instruction and the first policy instruction exceed one or more change criteria, a second node is generated. For example, a change criterion comprises one or more thresholds, such as a threshold number of different conditions associated with the first policy instruction and the second policy instruction, and/or a difference in priority between the first policy instruction and the second policy instruction. Optionally, the identifier associated with the second node is assigned to a first managed endpoint, e.g. step 910 of method 900.

Beneficially, method 1000 allows for the automated initiation of deployment of updated patch instructions to relevant managed endpoints based on detecting differences between previous policy instructions and new policy instructions. Initiation of deployment increases the security of the enterprise system, as updates can be scheduled or immediately pushed to managed endpoints without significant time delays. Additionally, small changes in the operation of the first managed endpoint result in the first managed endpoint applying patch instructions, such as due to a change in user or location of the first managed endpoints, as described further regarding FIG. 11.

Alternatively, an executable patch of instructions of a selected policy is applied directly to the first managed endpoint without any of the steps of method 1100. For example, “User X” of the first managed endpoint from Marketing department calls an enterprise system engineer and requests to use a USB stick. The enterprise system engineer, or other authorized person, can subsequently select policy “Marketing Department” and add patch “Enable USB storage” with condition “if logged-on user is User X”.

FIG. 11 shows a flowchart illustrating a method for determining whether a managed endpoint is affected by a change to a policy instruction. Specifically, FIG. 11 illustrates a method 1100 of evaluating conditional expressions associated with a first policy instruction and/or assessing if an executable patch instruction is relevant to a first managed endpoint and is compatible with the processes of method 100, 300, 400, 500, 600, 700, 800, 900, and/or 1000. For example, method 1100 is performed at a server, a first managed endpoint, or a combination thereof.

Method 1100 is a method for determining whether a first managed endpoint is affected by a change to a first policy instruction based on evaluation of conditional expressions and/or assessment of executable patch instructions. As mentioned above, method 1100 allows for the use of policy management rules based on managed endpoints to determine a base policy and policy management rules based on user identifiers to be implemented as patches on top of the base policy. Patches prevent the need for user-based policy assignment rules to be added as extra layers to the layered data structure, which would increase complexity and required computational resources required to operate the layered data structure. A patch can override executable policy instructions of the base policy or be in addition to the executable policy instructions of the base policy.

As patches are mapped to conditions regarding either the managed endpoint or user identifier, method 1100 contains a dual process for determining whether the first managed endpoint meets conditions associated with the patch or determining whether a user identifier associated with the first managed endpoint, such as a user logged into the first managed endpoint, meets conditions associated with the patch.

Method 1100 comprises step 1102 and optional step 1102, step 1104, step 1106, step 1108, step 1110, and/or step 1112. Step 1102 comprises determining whether a first managed endpoint is affected by a change to a first policy instruction by performing step 1104, evaluating one or more conditional expressions associated with the first policy instruction, and/or step 1106, determining if a stop criterion is met. Step 1102 comprises determining whether a first managed endpoint is affected by a change to a first policy instruction by performing step 1108, assessing if the executable patch instruction is relevant to the first managed endpoint, which can further comprise performing step 1110, obtaining a user identifier associated with the first managed endpoint. Step 1112 comprises implementing the executable patch instruction.

Evaluation of conditional expressions is used in determining whether the first managed endpoint meets the conditions associated with the first policy instruction. Determining if a stop criterion is met is an additional or alternative process for evaluating conditional expressions, depending on the stop criterion. Assessing if an executable patch instruction is relevant is based on previously deployed executable policy instructions, implementation requirements of the executable patch instruction, and/or information associated with the first managed endpoint. In one example, information associated with the first managed endpoint includes user identifiers associated with the first managed endpoint, and therefore method 1100 optionally requires obtaining a user identifier associated with the first managed endpoint.

Step 1102 comprises determining whether the first managed endpoint is affected by a change to a first policy instruction, which is described in detail is reference to step 908 of method 900. For example, step 1102 progresses to step 1104 and/or step 1108.

Step 1104 is an optional step comprising evaluating one or more conditional expressions associated with the first policy instruction. In one example, evaluating the one or more conditional expressions comprises determining whether the first managed endpoint satisfies the one or more conditional expressions. In another example, evaluating the one or more conditional expressions comprises analyzing the one or more conditional expressions and/or extracting key information from the one or more conditional expressions, such as extracting information associated with policy management of the first endpoint. Optionally, evaluation is performed at the server.

Step 1106 is an optional step. For example, step 1102 may progress to step 1106 without progressing to step 1104, step 1102 may progress to step 1104 without progressing to step 1106, or step 1104 may progress to step 1106. Step 1106 comprises determining if a stop criterion is met, wherein the stop criterion is associated with whether the first managed endpoint satisfies the one or more conditional expression, which can be performed according to the process of step 606 of method 600 and/or step 302 of method 300 and/or step 104 of method 100. Optionally, step 1106 progresses to step 1112.

Step 1108 is an optional step comprising assessing if the executable patch instruction associated with the first policy instruction is relevant to the first managed endpoint based on information associated with the first managed endpoint. Assessing comprises analyzing key information from the executable patch instruction, such as extracting the requirements associated with implementing the executable patch instruction. Assessing the executable patch instruction optionally comprises assessing the first policy instruction. Optionally, assessment is performed at the first managed endpoint.

In the previous example referenced in method 900 of FIG. 9, the executable patch instruction comprises instructions to not execute a previous executable policy instruction associated with the original first policy instruction (associated with not allowing use of peripheral optical disk drives) if the first managed endpoint does not satisfy the new condition (associated with not allowing use of the Blu-ray drive specifically). Optionally, assessing if the executable patch instruction is relevant includes determining whether the first managed endpoint is associated with a peripheral optical drive and whether that peripheral optical drive is a Blu-ray drive. If the first managed endpoint is associated with a peripheral DVD drive, the executable patch instruction is relevant to the first managed endpoint. Alternatively, executable patch instructions contain configuration options regarding particular components (e.g. Device Control). The tracking of active devices and the logic for applying permissive or blocking actions is part of the component itself.

Step 1110 is an optional step comprising obtaining a user identifier associated with the first managed endpoint. For example, the user identifier associated with the first managed endpoint is key information of step 1108. Alternatively, or additionally, a user identifier is obtained from the first managed endpoint and/or the server. For example, one or more conditional expressions associated with the first policy instruction are associated with one or more user requirements, wherein the executable patch instruction is relevant based on the user identifier associated with the first managed endpoint at a first timepoint.

The executable patch instruction may not be relevant based on a different user identifier associated with the first managed endpoint at a second timepoint, such as if the executable patch instruction is to be implemented only for a specific user group comprising the user identifier. For example, a user identifier could be associated with a first security privilege, which is then updated to a second security privilege. The change to a first policy instruction would reflect the change in security privilege associated with the user identifier, and the executable patch instruction is relevant to the first managed endpoint when the first managed endpoint is associated with the user identifier.

Step 1112 is an optional step comprising implementing the executable patch instruction. For example, if the stop criterion of step 1106 is met and/or the executable patch instruction is relevant to the first managed endpoint as of step 1108, the executable patch instruction is implemented at the first managed endpoint. Optionally, the first managed endpoint is a plurality of endpoints, wherein the executable patch instruction is implemented on multiple managed endpoints. Alternatively, or additionally, implementing the executable patch instruction comprising initiating deployment of the executable patch instruction to the first managed endpoint, such as using the process described in step 912 of method 900.

Following on from the above example in reference to step 1108, the first managed endpoint implements the executable patch instruction, allowing use of the peripheral DVD drive associated with the first managed endpoint.

Beneficially, method 1100 allows for targeted deployment of updated policy instructions and/or patch instructions to relevant managed endpoints based on identifying which managed endpoints require the updated patch instructions, preventing policy proliferation and increasing efficiency of the policy management system. Relevance can be assessed on conditions associated with the first managed endpoint, the updated policy instruction and/or patch instruction, and/or the user identifier associated with the first managed endpoint. Method 1100 can be repeated when a different user identifier is associated with the first managed endpoint, allowing for user-specific patch initiation, increasing the security of the enterprise system.

FIG. 12 shows an example system for orchestrating the organization, deployment, and/or updating of policy management rules. Specifically, FIG. 12 shows an example system for the implementation of any of methods 100, 300, 400, 500, 600, 700, 800, 900, 1000 and/or 1100. FIG. 12 also represents an example system for the generation and/or use of layered data structure 200 of FIG. 2. The components of policy management system 1200 are for example purposes and the skilled person would understand that each component is optional, wherein any component may be deleted, combined and/or separated into one or more components, and/or duplicated.

Policy management system 1200 comprises a policy controller 1202, policy inputs 1204, assignment inputs 1206, category inputs 1208, a first server 1210, and an enterprise environment 1212. The enterprise environment 1212 comprises, optionally, a control hub 1214 and a first managed endpoint 1216. Optionally, the enterprise environment 1212 further comprises any of a domain controller 1218, a second managed endpoint 1220, and a plurality of managed endpoints 1222. The control hub 1214 comprises a second server 1224 and optionally further comprises a first cache 1226, a second cache 1228, a third cache 1230, and a fourth cache 1232. Policy management system 1200 further comprises identification information 1234, policy information 1236, assignment information 1238, category information 1240, domain input 1242, policy output 1244, assignment output 1246, policy identification information 1248, assignment identification information 1250, category output 1252, and domain information 1254. Each managed endpoint is configured to communicate with the control hub 1214, shown by network connection 1256.

Policy management system 1200 is configured for the organization of policy management rules for distribution to the first endpoint 1216.

The first server 1210 receives a first set of control statements from one or more sources, such as policy inputs 1204, assignment inputs 1206 and category inputs 1208 from policy controller 1202. The first set of control statements (1204, 1206, 1208) are associated with policy management rules. The first server 1210 transforms the first set of control statements (1204, 1206, 1208) into a first set of conditional expressions based on predefined criteria, such as policy information 1236. The first set of conditional expressions are associated with properties of first managed endpoint 1216, second managed endpoint 1220, or the plurality of managed endpoints 1222, such as category information 1240, domain input 1242, and/or identification information 1234. The first server 1210 generates a layered data structure, such as layered data structure 200 of FIG. 2, comprising a plurality of layers, wherein each layer of the plurality of layers has one or more nodes. Optionally, policy controller 1202 and/or the first server 1210 is comprised within the enterprise environment 1212.

Each node of the one or more nodes is associated with an identifier. The identifier is associated with a policy identifier and/or a matched rule identifier, such as policy identification information 1248 and assignment identification information 1250, which are communicated to the first server 1210 with identification information 1234. Each node is further associated with one or more conditional expressions of the first set of conditional expressions, and one or more executable policy instructions. The one or more executable policy instructions represent executable code for implementation on the one or more managed endpoints (for example first managed endpoint 1216, second managed endpoint 1220, or the plurality of managed endpoints 1222), and are associated with policy output 1244 and assignment output 1246. For example, policy output 1244 and assignment output 1246 is one or more executable policy instructions deployed to the first managed endpoint 1216.

Policy management system 1200 is further configured to initiate distribution of the one or more executable policy instructions to the first managed endpoint 1216 based on the layered data structure. For example, the control hub 1214 deploys one or more executable policy instructions to the first managed endpoint 1216 based on an initiation, such as a request received from the policy controller 1202, the first server 1210, the control hub 1214 or any of first managed endpoint 1216, second managed endpoint 1220, or the plurality of managed endpoints 1222. The one or more executable policy instructions are deployed to second managed endpoint 1220 via network connection 1256.

The policy management rules comprise one or more of: policy content access, policy assignment, or endpoint classifications. For example, policy inputs 1204 comprises policy content and/or access policies relevant to the enterprise environment 1212, wherein policy inputs are obtained from one or more policy controllers 1202. Assignment inputs 1206 comprises policy assignment rules and conditions and category inputs 1208 comprises any of custom-defined groups, endpoint-based classifications, user-based classifications, or other categorization data.

The first server 1210 is any of a cloud server, a local server, or a computing device and/or system. The first server 1210 is further configured to optimize the first set of conditional expressions, wherein optimizing optionally comprises analyzing the first set of conditional expressions for conflicts. Additionally or alternatively, the first server 1210 is configured to render the layered data structure.

Transforming, at the first server 1210, the first set of control statements into a first set of conditional expressions based on predefined criteria comprises structuring the first set of control statements based on predefined criteria and/or generating the first set of conditional expressions based on the structured first set of control statements. Structures include tables, lists, databases, or other method for organizing multiple data entries. The predefined criteria comprise requirements associated with satisfying the policy management rules, such as a location associated with, for example, the first managed endpoint 1216, a user identifier associated with, for example, the first managed endpoint 1216, or data attributes associated with, for example, the first managed endpoint 1216. Ordering the first set of control statements is optionally based on a determined priority associated with each control statement of the first set of control statements. Optionally, conditional expressions are structured in a uniform format. For example, the conditional expressions represent if/else statements, comprise script language code, and/or comprise readable human language.

Information associated with the first managed endpoint comprises any of: policy identification information 1248; assignment identification information 1250; category output 1252; and domain information 1254 including defined group classification data; system information; hardware information; system health data; installed applications; and/or detected threats. Information associated with the first managed endpoint is obtained from control hub 1214, domain controller 1218, policy controller 1202, the first managed endpoint 1216, and/or the second managed endpoint 1220. The first server 1210 and/or the control hub 1214 and/or the first managed endpoint 1216 is configured to assess or request an assessment of the first set of conditional expressions based on the information associated with the first managed endpoint. Information associated with the first managed endpoint is optionally stored at the server, such as in first cache 1226, second cache 1228, third cache 1230, and/or fourth cache 1232. Optionally, the first managed endpoint is configured to assess the first set of conditional expressions based on information associated with the first managed endpoint, wherein the information is stored locally.

Beneficially, one or more caches in the control hub allows for the first server 1210 to be disconnected from enterprise environment 1212 without impacting the deployment of executable patch instructions based on the layered data structure to the first managed endpoint 1216. For example, the first server 1210 stores the conditional expressions in first cache 1226, and/or stores the control statements in second cache 1228.

Policy management system 1200 is further configured for deploying policy management rules to first managed endpoint 1216.

Control hub 1214 or a different server obtains a layered data structure, such as the layered data structure generated by first server 1210. The layered data structure comprises a plurality of layers, each layer of the plurality of layers having one or more nodes, wherein each node of the one or more nodes is associated with an identifier, one or more conditional expressions, and one or more executable policy instructions. Control hub 1214 or a managed endpoint such as first managed endpoint 1216 determines, for a first node within a first layer of the layered data structure, whether a stop criterion is met (such as performed using the processes described in reference to step 104 of method 100, step 302 of method 300, 606 of method 600, or step 1106 of method 1100). The stop criterion is associated with whether the first managed endpoint satisfies one or more conditional expressions associated with a node of the one or more nodes.

In the event the stop criterion is met, the identifier associated with the first node is assigned to the first managed endpoint 1216. In the event the stop criterion is not met, a subsequent node is traversed to in the layered data structure until the stop criterion is met. The identifier associated with the subsequent node is assigned to the first managed endpoint 1216. Assignment is performed by the first managed endpoint 1216, a different managed endpoint (1220 or 1222), control hub 1214, or the first server 1210. Optionally, traversing to a subsequent node comprises traversing to a subsequent layer of the layered data structure.

The assigning device, such as control hub 1214, or a different component, such as first server 1210, initiates deployment of the one or more executable policy instructions to the first managed endpoint 1216 based on the assigned identifier. For example, if the first managed endpoint 1216 is assigned the identifier associated with the first node, the one or more executable policy instructions associated with the first node are deployed to the first managed endpoint 1216. Policy management system 1200 is configured to repeat the above steps of assigning and initiating deployment for second managed endpoint 1220 and the plurality of managed endpoints 1222.

Policy management system 1200 is further configured for distribution of updated policy management instructions to one or more managed endpoints.

The first server 1210, control hub 1214, and/or a first managed endpoint 1216 identifies a change to a first policy instruction associated with the one or more executable policy instructions. For example, the first policy instruction is an updated control statement received from policy controller 1202. Identifying a change is described in detail in reference to the method 1000 of FIG. 10. The first server 1210 and/or control hub 1214 generates an executable patch instruction, wherein the executable patch instruction represents the change to the first policy instruction. Generating an executable patch instruction is described in detail in reference to method 900 of FIG. 9. The first server 1210 and/or control hub 1214 determines whether a first managed endpoint 1216 of the one or more managed endpoints (1220, 1222) is affected by the change to the first policy instruction, described in detail in reference to method 1100 of FIG. 11. In the event the first managed endpoint 1216 is affected, the identifier associated with a first node of the one or more nodes is assigned to the first managed endpoint 1216. Deployment of the executable patch instruction to the first managed endpoint 1216 based on the assigned identifier is then initiated, for example through policy output 1244 and/or assignment output 1246.

Implementation of a control hub 1214 in policy management system 1200 is optional as, for example, processes or components of the control hub 1214 can instead be performed by the first server 1210. An example of the policy management system 1200 with the control hub 1214 and a separate example of the policy management system 1200 without the control hub 1214 is described below.

In one example without the control hub 1214, the first server 1210 interacts directly with the first managed endpoint 1216. The first server 1210 obtains a layered data structure, such as by generating a layered data structure or receiving the layered data structure from a storage medium and/or a second server. The first managed endpoint 1216 receives one or more sets of conditional expressions associated with one or more nodes of the layered data structure and assesses whether the first managed endpoint 1216 satisfies a first set of conditional expressions associated with a first node. Based on this assessment, the first managed endpoint 1216 determines whether a stop criterion is met for the first node is met. If the stop criterion is met, the first managed endpoint 1216 is assigned the identifier associated with the first node. This can be used to directly map the first node with the first managed endpoint 1216 at the first server 1210 or the policy controller 1202. The first managed endpoint 1216, the first server 1210, or the policy controller 1202 then initiates deployment of one or more executable policy instructions associated with the first node to the first managed endpoint 1216. If the executable policy instructions are stored at the first managed endpoint 1216, deployment results in execution of policy management rules at the first managed endpoint 1216. If the executable policy instructions are not stored or otherwise accessible at the first managed endpoint 1216, the first managed endpoint 1216 received the one or more executable policy instructions from the first server 1210. Optionally, first managed endpoint 1216 is also policy controller 1202, wherein policy controller 1202 is first managed endpoint 1216 configured for a policy administrator. Beneficially, the example system without control hub 1214 is centrally controlled with reduced resource requirements, as the server obtains the layered data structure while assessing conditional expressions is delegated.

Alternatively, control hub 1214 acts as an intermediary between the first server 1210 and the first managed endpoint 1216. For example, data associated with the layered data structure such as the formation and/or order of the layered data structure, the conditional expressions, the executable policy instructions, and/or the original policy rules, is stored in first cache 1226, second cache 1228, third cache 1230, and/or fourth cache 1232. The first managed endpoint 1216 receives sets of conditional expressions from the control hub 1214 and assesses whether the first managed endpoint 1216 satisfies a first set of conditional expressions associated with a first node. Based on this assessment, the first managed endpoint 1216 determines whether a stop criterion is met for the first node is met. If the stop criterion is met, the first managed endpoint 1216 is assigned the identifier associated with the first node. This can be used to directly map the first node with the first managed endpoint 1216 at the control hub 1214. The first managed endpoint 1216 or the control hub 1214 then initiates deployment of one or more executable policy instructions associated with the first node and stored at the control hub 1214 to the first managed endpoint 1216. Beneficially, the inclusion of control hub 1214 allows for the management of policies even in an air-gap environment wherein the enterprise environment 1212 is operational without continual communication between the control hub 1214 and the first server 1210. The control hub 1214 therefore increases the security of the enterprise system.

FIG. 13 shows an example computing system for orchestration of the organization, deployment, and/or updating of policy management rules. Specifically, FIG. 13 shows a block diagram of an embodiment of a computing system according to example embodiments of the present disclosure.

Computing system 1300 can be configured to perform any of the operations disclosed herein such as, for example, any of the operations discussed with reference to method 100, 300, 400, 500, 600, 700, 800, 900, 1000, 1100, layered data structure 200 of FIG. 2, and/or policy management system 1200 of FIG. 12. Computing system includes one or more computing device(s) 1302. Computing device(s) 1302 of computing system 1300 comprise one or more processors 1304 and memory 1306. One or more processors 1304 can be any general purpose processor(s) configured to execute a set of instructions. For example, one or more processors 1304 can be one or more general-purpose processors, one or more field programmable gate array (FPGA), and/or one or more application specific integrated circuits (ASIC). In one embodiment, one or more processors 1304 include one processor. Alternatively, one or more processors 1304 include a plurality of processors that are operatively connected. One or more processors 1304 are communicatively coupled to memory 1306 via address bus 1308, control bus 1310, and data bus 1312. Memory 1306 can be a random access memory (RAM), a read only memory (ROM), a persistent storage device such as a hard drive, an erasable programmable read only memory (EPROM), and/or the like. Computing device(s) 1302 further comprise I/O interface 1314 communicatively coupled to address bus 1308, control bus 1310, and data bus 1312.

Memory 1306 can store information that can be accessed by one or more processors 1304. For instance, memory 1306 (e.g., one or more non-transitory computer-readable storage mediums, memory devices) can include computer-readable instructions (not shown) that can be executed by one or more processors 1304. The computer-readable instructions can be software written in any suitable programming language or can be implemented in hardware. Additionally, or alternatively, the computer-readable instructions can be executed in logically and/or virtually separate threads on one or more processors 1304. For example, memory 1306 can store instructions (not shown) that when executed by one or more processors 1304 cause one or more processors 1304 to perform operations such as any of the operations and functions for which computing system 1300 is configured, as described herein. In addition, or alternatively, memory 1306 can store data (not shown) that can be obtained, received, accessed, written, manipulated, created, and/or stored. The data can include, for instance, the data and/or information described herein in relation to the present disclosure. In some implementations, computing device(s) 1302 can obtain from and/or store data in one or more memory device(s) that are remote from the computing system 1300.

Computing system 1300 further comprises storage unit 1316, network interface 1318, input controller 1320, and output controller 1322. Storage unit 1316, network interface 1318, input controller 1320, and output controller 1322 are communicatively coupled to central control unit via I/O interface 1314.

Storage unit 1316 is a computer readable medium, which may be transitory or non-transitory computer readable medium, comprising one or more programs, the one or more programs comprising instructions which when executed by the one or more processors 1304 cause computing system 1300 to perform the method steps of the present disclosure. Alternatively, storage unit 1316 is a transitory computer readable medium. Storage unit 1316 can be a persistent storage device such as a hard drive, a cloud storage device, or any other appropriate storage device.

Network interface 1318 can be a Wi-Fi module, a network interface card, a Bluetooth module, and/or any other suitable wired or wireless communication device. In an embodiment, network interface 1318 is configured to connect to a network such as a local area network (LAN), or a wide area network (WAN), the Internet, or an intranet.

At this point it should be noted that orchestration of the methods of the present disclosure as described above may involve the processing of input data and the generation of output data to some extent. This input data processing and output data generation is implemented in hardware or software. For example, specific electronic components are employed in a control module or similar or related circuitry for implementing the functions associated with the methods in accordance with the present disclosure as described above. Alternatively, one or more processors operating in accordance with instructions may implement the functions associated with the methods in accordance with the present disclosure as described above. If such is the case, it is within the scope of the present disclosure that such instructions are stored on one or more transitory, or non-transitory, processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure is beneficially implemented in any number of environments for any number of purposes. Accordingly, the statements set forth below should be construed in view of the full breadth and spirit of the present disclosure as described herein.

1.-118. (canceled)

119. A computer program product comprising computer executable code stored on a non-transitory computer readable medium that, when executing on one or more computing devices, causes the one or more computing devices to perform the steps of:
obtaining, at a server, a layered data structure comprising a plurality of layers, each layer of the plurality of layers having one or more nodes, wherein each node of the one or more nodes is associated with:
an identifier,
one or more conditional expressions, and
one or more executable policy instructions;
determining, for a first node within a first layer of the layered data structure, whether a stop criterion is met, wherein the stop criterion is associated with whether a first managed endpoint satisfies the one or more conditional expressions associated with a node of the one or more nodes;
in response to determining that the stop criterion is met, assigning a first identifier associated with the first node to the first managed endpoint, and
in response to determining that the stop criterion is not met,
traversing to a subsequent node in the layered data structure and assessing a subsequent set of conditional expressions associated with the subsequent node in the layered data structure until the stop criterion is met, and
assigning a second identifier associated with the subsequent node to the first managed endpoint; and
initiating deployment of the one or more executable policy instructions to the first managed endpoint based on an assigned identifier.

120. The computer program product of claim 119 wherein at least one of the one or more nodes of the layered data structure is a further layered data structure.

121. The computer program product of claim 119, wherein the layered data structure is a hierarchical tree.

122. The computer program product of claim 119, wherein one of the one or more nodes includes at least one of: one or more access right definitions, data describing the one of the one or more nodes, and a policy identifier.

123. The computer program product of claim 119, wherein the one or more conditional expressions of one of the one or more nodes are associated with one or more of policy content for an enterprise environment, an access policy for the enterprise environment, a policy assignment, and an endpoint classification.

124. The computer program product of claim 119, further comprising code that performs the steps of:
receiving, at the server, information associated with the first managed endpoint from one or more sources; and
using the information associated with the first managed endpoint for determining whether the first managed endpoint satisfies the one or more conditional expressions associated with the node of the one or more nodes.

125. The computer program product of claim 124, wherein the information associated with the first managed endpoint comprises domain group data received from a domain controller.

126. The computer program product of claim 124, wherein the information associated with the first managed endpoint is received from the first managed endpoint.

127. The computer program product of claim 124, wherein the information associated with the first managed endpoint includes one or more of defined group classification data, system information, hardware information, system health data, installed applications, and detected threats.

128. The computer program product of claim 119, wherein initiating the deployment of the one or more executable policy instructions to the first managed endpoint further comprises:
identifying a node associated with the assigned identifier for the first managed endpoint, the assigned identifier including the first identifier or the second identifier; and
outputting the one or more executable policy instructions associated with an identified node to the first managed endpoint.

129. The computer program product of claim 119, wherein initiating the deployment of the one or more executable policy instructions to the first managed endpoint further comprises:
receiving a node selection, wherein the node selection indicates a specific node within the layered data structure; and
deploying the one or more executable policy instructions associated with the specific node of the node selection based on a specific node identifier associated with the specific node.

130. The computer program product of claim 119, wherein initiating the deployment of the one or more executable policy instructions to the first managed endpoint comprises initiating execution of one or more policy instructions at the first managed endpoint.

131. A method comprising:
obtaining, at a server, a layered data structure comprising a plurality of layers, each layer of the plurality of layers having one or more nodes, wherein each node of the one or more nodes is associated with:
an identifier,
one or more conditional expressions, and
one or more executable policy instructions;
determining, for a first node within a first layer of the layered data structure, whether a stop criterion is met, wherein the stop criterion is associated with whether an endpoint managed by the server satisfies the one or more conditional expressions associated with a node of the one or more nodes;
if the stop criterion is met, assigning the identifier associated with the first node to the endpoint;
if the stop criterion is not met, traversing to a subsequent node in the layered data structure until the stop criterion is met and assigning the identifier associated with the subsequent node to the endpoint; and
initiating deployment of the one or more executable policy instructions to the endpoint based on the identifier.

132. The method of claim 131, further comprising the step of repeating the method for one or more further managed endpoints.

133. The method of claim 131, wherein at least one of the one or more nodes of the layered data structure is a further layered data structure.

134. The method of claim 131, wherein the layered data structure is a hierarchical tree.

135. The method of claim 131, wherein the node of the one or more nodes includes at least one of: one or more access right definitions, data describing the node, and a policy identifier.

136. A system comprising:
an enterprise environment;
an endpoint associated with the enterprise environment; and
a server for managing security of the endpoint in the enterprise environment, the server configured by computer executable code to perform the steps of:
obtaining a layered data structure comprising a plurality of layers, each layer of the plurality of layers having one or more nodes, wherein each node of the one or more nodes is associated with:
an identifier,
one or more conditional expressions, and
one or more executable policy instructions;
determining, for a first node within a first layer of the layered data structure, whether a stop criterion is met, wherein the stop criterion is associated with whether the endpoint satisfies the one or more conditional expressions associated with a node of the one or more nodes;
in response to determining that the stop criterion is met, assigning the identifier associated with the first node to the endpoint;
in response determining that the stop criterion is not met, traversing to a subsequent node in the layered data structure until the stop criterion is met and assigning the identifier associated with the subsequent node to the endpoint; and
initiating deployment of the one or more executable policy instructions to the endpoint based on an assigned identifier.

137. The system of claim 136, the server further configured to perform the steps of:
receiving, at the server, information associated with a first managed endpoint from one or more sources; and
using the information associated with the first managed endpoint for determining whether the first managed endpoint satisfies the one or more conditional expressions associated with the node of the one or more nodes.

138. The system of claim 136, further comprising a second server configured to generate the layered data structure by performing the steps of:
receiving a first set of control statements from one or more sources, wherein the first set of control statements are associated with policy management rules for the enterprise environment; and
transforming, at the server, the first set of control statements into a first set of conditional expressions based on predefined criteria, wherein the first set of conditional expressions are associated with properties of one or more managed endpoints associated with the enterprise environment.
